(19) United States
(12) Patent Application Publication
(10) Pub. No.: US 2018/0147773 A1
(43) Pub. Date: May 31, 2018

(54) MATERIAL EXTRUSION ADDITIVE MANUFACTURING OF POLYIMIDE PRECURSOR

(71) Applicant: SABIC Global Technologies B.V., Bergen op Zoom (NL)

(72) Inventors: Viswanathan Kalyanaraman, Newburgh, IN (US); Erich Otto Teutsch, Richmond, MA (US); Thomas Hocker, Pittsfield, MA (US); Brian Price, Evansville, IN (US)

(21) Appl. No.: 15/579,348

(22) PCT Filed: Jun. 2, 2016
(86) PCT No.: PCT/IB2016/053246

§ 371 Date: Dec. 4, 2017

Related U.S. Application Data
(60) Provisional application No. 62/170,423, filed on Jun. 3, 2015.

(51) Int. Cl. B29C 64/106; B29C 64/209; C08G 73/10; C08L 79/08; B33Y 10/00; B33Y 70/00

(52) U.S. Cl. CPC B29C 64/106; B29C 64/209; C08G 73/1032; B29K 2079/08; C08L 79/08; B33Y 10/00; B33Y 70/00; C08G 73/1053

(57) ABSTRACT

A system comprises an extrusion head to selectively extrude a bead of a precursor solution onto a target road on a substrate within a build area, the precursor solution comprising a polyimide precursor compound in a solvent, an actuator coupled to the extrusion head to move the extrusion head, a control system coupled to the actuator to control the extrusion head along the target road and selectively dispense the precursor solution to the extrusion head, and an environmental system configured to accommodate the target road during fabrication, the environmental system configured to expose the dispensed precursor solution to a temperature selected to evaporate solvent from the solution to initiate polymerization of the polyimide precursor compound to form at least a portion of a polyimide part.

### BACKGROUND

On-demand fabrication of articles using three-dimensional (3D) computer-assisted design (CAD) data, also referred to as additive manufacturing or 3D printing, has been improving and becoming more prevalent. 3D printing technologies can include several different technology methods. One such method is referred to as material extrusion, also known as fused deposition modeling or fused filament fabrication, which involves extruding a material through an extrusion nozzle to form roads to fabricate parts in a layer-by-layer manner.

### SUMMARY

The present disclosure describes a system and methods for material extrusion of a reactive polyimide precursor compound to enable reactive polymerization of the precursors in order to form a polyimide part.

The present inventors have recognized, among other things, that a problem to be solved includes poor diffusion and crosslinking between adjacent beads or layers of articles fabricated by material extrusion additive manufacturing, resulting in poor adhesion between adjacent the adjacent roads or layers, particularly for high-molecular weight polymers such as polyimides. The present subject matter described herein can provide a solution to this problem, such as by providing for material extrusion of a reactive polyimide precursor compound that react and crosslink between layers, providing for better adhesion between layers.

The present inventors have recognized, among other things, that a problem to be solved included poor contact between adjacent roads or layers due to large viscosities for polymer articles fabricated by material extrusion additive manufacturing, resulting in poor adhesion between adjacent the adjacent roads or layers, particularly for high-molecular weight polymers such as polyimides. The present subject matter described herein can provide a solution to this problem, such as by providing for material extrusion of a reactive polyimide precursor compound that provide larger contact area and reflow between adjacent roads and layers, providing for better adhesion between layers. The present subject matter described herein can also provide a solution to this problem by provided for an extruded bead with substantially flat sides that can provide for improved contact between adjacent roads.

The present inventors have recognized, among other things, that a problem to be solved can include limited ability to control the final properties of a polyimide formed by rapid prototyping, such as molecular weight, density, tensile strength and other physical properties. The present subject matter described herein can provide a solution to this problem, such as by providing for control over physical properties of a final polyimide material by controlling initial properties of the polyimide precursor solution that is printed.

### BRIEF DESCRIPTION OF THE FIGURES

FIG. 1 is a schematic diagram of an example system for fabricating a polyimide article by selective extrusion of a reactive polyimide precursor solution.

FIGS. 2A and 2B are conceptual cross-sectional views of example extrusion heads that can be used in the example system of FIG. 1.

FIGS. 3A and 3B are cross-sectional view of the example extruded beads taken along line 3-3 in FIG. 1.

FIG. 4 is cross-sectional view of an example extrusion head configured to directly heat the polyimide precursor solution during extrusion to form a bead of the polyimide precursor solution.

FIG. 5 is a cross-sectional view of the heating portion of the extrusion head taken along lines 5-5 in FIG. 4.

FIG. 6 is cross-sectional view of another example extrusion head configured to non-uniformly directly heat the polyimide precursor solution during extrusion to form a non-uniformly polymerized bead of the polyimide precursor solution.

FIG. 7 is a cross-sectional view of the heating portion of the extrusion head taken along lines 7-7 in FIG. 6.

FIG. 8 is a cross-sectional view of an example non-uniformly polymerized extruded bead taken along line 8-8 in FIG. 6.

FIG. 9 is a schematic diagram of another example system for fabricating a polyimide article by selective extrusion of reactive polyimide precursor solutions.

FIG. 10 is a top view of a reactive build material bead of a polyimide precursor solution formed by combining first and second precursor solution beads extruded from the example system of FIG. 9.

FIG. 11 is a flow diagram of an example method of fabricating a polyimide part via material extrusion of a reactive polyimide precursor solution.

FIG. 12 is a flow diagram of another example method of fabricating a polyimide part via material extrusion of first and second reactive polyimide precursor solutions.

### DETAILED DESCRIPTION

The present disclosure describes material extrusion additive manufacturing of structures including polyimide by selectively depositing a reactive polyimide precursor solution to form the structure. An extrusion head can be selectively directed within a target area as defined by a selected coordinate system, such as Cartesian and polar coordinate systems to deposit the polyimide precursor solution onto a substrate to build a bead that forms a portion of the structure. The extruded polyimide precursor solution can be exposed to an environment that causes a polyimide precursor compound within the polyimide precursor solution to polymerize the polyimide precursor compound into a polyimide polymer, forming at least a portion of the structure including polyimide.

In some examples where a multi-layer structure is fabricated, a first precursor layer of a structure can be built by selectively depositing the polyimide precursor solution as one or more beads along a “road” corresponding to the cross-section of the first layer. The first precursor layer can be at least partially polymerized, for example by heating the first precursor layer in order to evaporate solvent from the solution and initiate polymerization of the polyimide precursor compound. The build chamber into which the precursor layers are being deposited can be heated to a selected polymerization temperature to at least partially polymerize the polyimide precursor compound to a selected molecular weight. In some examples, at least a portion of extruded bead of the polyimide precursor solution can be in a B-stage-like state that is capable of supporting itself and the layers that are to be deposited thereon so that a plurality of precursor layers (comprising one or more beads of the polyimide precursor solution) can be extruded before polymerizing the polyimide precursor compound.

After the first precursor layer is printed, and optionally at least partially polymerized, the built first layer can be moved, e.g., downward, and a second precursor layer can be deposited on top of the first precursor layer by selectively depositing the polyimide precursor solution as one or more beads corresponding to a cross section of a second part layer. The second layer can be at least partially polymerized or, as noted above, the polyimide precursor solution can be extruded in a B-stage-like state and a plurality of the precursor layers, such as all of the precursor layers, can be polymerized at the same time to form the polyimide part. This process can be repeated with a third part layer, a fourth part layer, a fifth part layer, and so on, until the part is completed.

Fully polymerized polyimides are not currently used broadly in material extrusion manufacturing because polyimides, as amorphous polymer resins, demonstrate broad softening behavior when heated. Once they are heated to the point of flowing, their viscosity doesn't typically allow air trapped around the extruded beads to flow out of the melt pool. This results in air-bubbles becoming entrapped in the extruded bead, which can degrade mechanical performance. This can result in the final structure leaving behind a relatively high porosity. In addition, because polyimides often melt incompletely, air and other gases can become trapped in void spaces within the resulting structure. The relatively large porosity and trapped air or gas in the void spaces can lead to the resulting parts having relatively low densities and relatively low part strength. In addition, extrusion-printed polyimide beads often achieve poor adhesion between the occurrent layer, e.g., the layer being actively printed, and the antecedent layer or layers, e.g., the layers beneath the occurrent layer. Poor adhesion is believed to occur because of the large viscosity of molten polyimide, limited molecular diffusion between the occurrent layer and the one or more antecedent layers, and typically large temperature differences between the occurrent layer and the antecedent layer or layers.

The present disclosure describes systems and methods that are useful for extrusion-based additive manufacturing of a polyimide precursor compound to fabricate polyimide articles. The systems and methods described herein involve selective dispensing of a polyimide precursor solution comprising a precursor compound that can be subsequently or concurrently polymerized into a polyimide polymer to form a polyimide polymer structure.

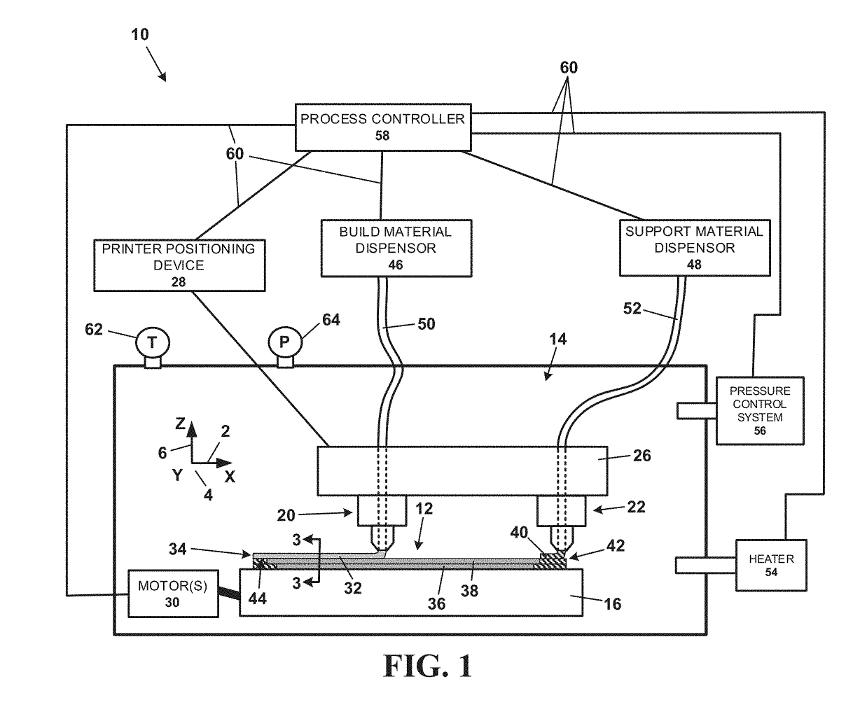

FIG. 1 shows an example extrusion system 10 for fabricating a structure 12 including polyimide by extruding a polyimide precursor solution. The system 10 can include a build chamber 14 enclosing a substrate 16 onto which the structure 12 is to be built. As described in more detail below, the precursor solution can comprise a compound that can react and polymerize to form a final polyimide material of the structure 12 including polyimide. The precursor solution can comprise, in a solvent, one or more of: a bisanhydride precursor compound; a diamine precursor compound; or a reaction product of a bisanhydride precursor compound and a diamine precursor compound. The polyimide precursor compound can be polymerized by heating the polyimide precursor solution, which results in the removal of solvent from the solution and initiates polymerization of the polyimide precursor compound to form the polyimide polymer that will make up the polyimide portions of the structure 12.

The system 10 can include a first extrusion head 20 to selectively extrude the precursor solution, which can also be referred to as the build extrusion head 20 to dispense the build material solution. The system 10 can include a second extrusion head 22 to selectively dispense a support material, also referred to as a support extrusion head 22.

The extrusion heads 20, 22 can be configured to be moved relative to the substrate 16 so that the extrusion heads 20, 22 can be directed along an extrusion path, also referred to herein as a road. For example, the extrusion heads 20, 22 can be coupled to a head block 26 that can be moved over the substrate 16 to direct the extrusion heads 20, 22 along a desired road. The head block 26 can be movable in any direction within a selected coordinate system, such as Cartesian and polar coordinate systems. The head block 26 can be movable over the substrate 16 in an X-direction 2 (shown as being from left to right in FIG. 1). The head block 26 can be movable over the substrate 16 in a Y-direction 4 (shown as being into and out of the page in FIG. 1). The X-direction 2 can be substantially orthogonal to the Y-direction 4. Both the X- and Y-directions 2, 4 can be substantially parallel to the top surface of the substrate 16. The head block 26 can be movable by an extrusion head actuator 28 according to the selected coordinate system, e.g., by moving the head block 26 along the X-direction 2 and the Y-direction 4 over the substrate 16, such as with at least one of: one or more motors and one or more screw drives. The actuator 28 can also move the head block 26 in a Z-direction 6 (shows as being up and down in FIG. 1). The Z-direction 6 can be substantially orthogonal to one or more of the X-direction 2, the Y-direction 4, and the top surface of the substrate 16. The extrusion heads 20, 22 can be moved separately, e.g., by its own actuator. The substrate 16 can be movable in one or more directions, such as one or more of the X-, Y-, and Z-directions 2, 4, 6 by a separate substrate actuator, such as one or more motors 30.

The build extrusion head 20 can dispense one or more beads 32 of the polyimide precursor material to form one or more occurrent precursor layers 34 on top of the substrate 16 or any previously-deposited antecedent layers 36, 38. The support extrusion head 22 can dispense one or more support beads 40 of the support material to support overhangs 44 of the build material layers 34, 36, 38. After the structure 12 has been completed, e.g., all build material layers have been deposited, the support structures 42 can be removed, such as by dissolution with a solvent, so that only the build material layers remain in the structure 12 including polyimide.

As is further shown in FIG. 1, the system 10 can include one or more devices to dispense the solutions to the extrusion heads 20, 22. The system 10 can include a first dispenser 46 to dispense a first fluid, e.g., the polyimide precursor solution, to the build extrusion head 20. The system 10 can include a second dispenser 48 to dispense a second fluid, for example to dispense the support material to the support extrusion head 22. The dispensers 46, 48 can include a reservoir for the fluid being dispensed to the respective extrusion head 20, 22. The dispensers 46, 48 can include pump or other fluid displacement device to move the fluid from the reservoir to the corresponding extrusion head 20, 22. The fluids can be fed to the extrusion heads 20, 22 through flexible conduits, such as flexible tubing and piping, to accommodate movement of the extrusion heads 20, 22. A first flexible conduit 50 can carry the build material precursor solution to the build extrusion head 20. A second flexible conduit 52 can carry the support material to the support extrusion head 22.

The system 10 can include an environmental system to control the conditions to which the extruded materials are exposed. The environmental system can facilitate polymerization of the polyimide precursor compound, e.g., one or more of a bisanhydride precursor and a diamine precursor compound or a reaction product thereof. The environmental system can control the conditions in order to facilitate formation of the support structures 36. The environmental system can control one or both of a selected temperature and a selected pressure. The environmental system can include a heater 54 to control temperature within the build chamber 14. The heater 54 can heat the build chamber 14 to a reaction temperature to initiate and propagate a polymerization reaction between the first and second polyimide precursor compounds or of a reaction product of the first and second polyimide precursor compounds into a solidified or substantially solidified polyimide polymer to form the structure 12 including polyimide. For polymerization of a bisanhydride precursor compound and a diamine precursor compound, the heater 54 can be configured to heat the build chamber 14 to a reaction temperature of from about 100° C. to about 400° C., such as from about 250° C. to about 500° C., for example from about 300° C. to about 450° C.

The actual reaction temperature provided by the heater 54 can depend on a number of factors, including the concentrations of the polyimide precursor compounds in the bead 32 and a selected reaction rate for the polymerization of the polyimide precursor compound. The selected reaction rate can be fast enough such that the occurrent layer 34 polymerizes to such an extent that the occurrent layer 34 can support printing of a subsequent layer, e.g., to at least a B-stage level of polymerization. The reaction rate can be selected to be slow enough so that final polymerization and solidification of the occurrent layer 34 does not occur until after the subsequent layer has been printed. This slow reaction rate can allow the fluid of the extruded bead or beads 32 that form the occurrent layer 34 to further combine with the immediate antecedent layer 38 and with a subsequently printed layer to form a substantially continuous structure 12 including polyimide. A slow reaction rate can allow for at least partial crosslinking between the occurrent layer 34 and the immediately antecedent layer 38 and any subsequently printed layer. Such crosslinking can provide for a stronger part than would occur if the cross-linking did not occur. The environmental system can include a pressure control system 56 to control a pressure within the build chamber 14. The pressure in the build chamber 14 can be controlled so that the pressure experienced by the occurrent layer 34 can be optimized for polymerization of the polyimide precursors.

The system 10 can include a control system to control one or more components of the system 10, such as one or more of the extrusion heads 20, 22, the actuator 28, the one or more motors 30 (if present), and the dispensers 46, 48. The control system can ensure that the one or more beads 32 are printed at specified times and onto the target roads 26. The control system can include one or more process controllers 58 that can process and provide instructions to one or more components of the system. The one or more process controllers 58 can take the form of any processing or controlling device capable of providing the instructions, including, but not limited to, one or more microprocessors, one or more controllers, one or more digital signal processor (DSP), one or more application-specific integrated circuit (ASIC), one or more field-programmable gate array (FPGA), and other digital logic circuitry. The instructions provided by the one or more process controller 58 can take the form of electrical signals via one or more communication links 60. The communication links 60 can be any wired or wireless connection that can transmit signals between the one or more process controller 58 and the one or more components receiving the signals.

The one or more process controllers 58 can be configured to control the environmental system. The one or more process controllers 58 can control the heater 54. The one or more process controllers 58 can control the pressure control system 56. The one or more process controllers 58 can control reaction conditions within the build chamber 14 to facilitate polymerization of the polyimide precursor compound. The one or more process controllers 58 can control the heater 54 through a feedback system, such as with a temperature sensor 62 that can determine the temperature within the build chamber 14 and provide a temperature reading signal to the one or more process controllers 58. The one or more process controllers 58 can provide a control signal to the heater 54 to adjust the temperature in the build chamber 14 in order to reach a desired set point temperature. The one or more process controllers 58 can control the pressure control system 56 through a feedback system, such as with a pressure sensor 64 that can determine the pressure within the build chamber 14 and provide a pressure reading signal to the process controller 58. The one or more process controllers 58 can provide a control signal to the pressure control system 56 to adjust the pressure within the build chamber 14 in order to reach a desired set point pressure.

The polyimide precursor solution extruded by the build extrusion head 20 can comprise a first polyimide precursor compound (e.g., a bisanhydride precursor compound) and a second polyimide precursor compound (e.g., a diamine precursor compound). The build extrusion head 20 can provide for mixing of a first precursor solution and a second precursor solution together at or near the extrusion head to form the final polyimide precursor solution that is extruded to form a bead (e.g., bead 32). The first precursor solution can comprise a first polyimide precursor compound, such as a bisanhydride precursor compound, in a first solvent. The second precursor solution can comprise a second polyimide precursor compound, such as a diamine precursor compound, in a second solvent. The first and second precursor solutions can be fed separately to the build extrusion head 20, and the build extrusion head 20 can include one or more structures to provide a mixing zone at, within, or proximate to the extrusion head.

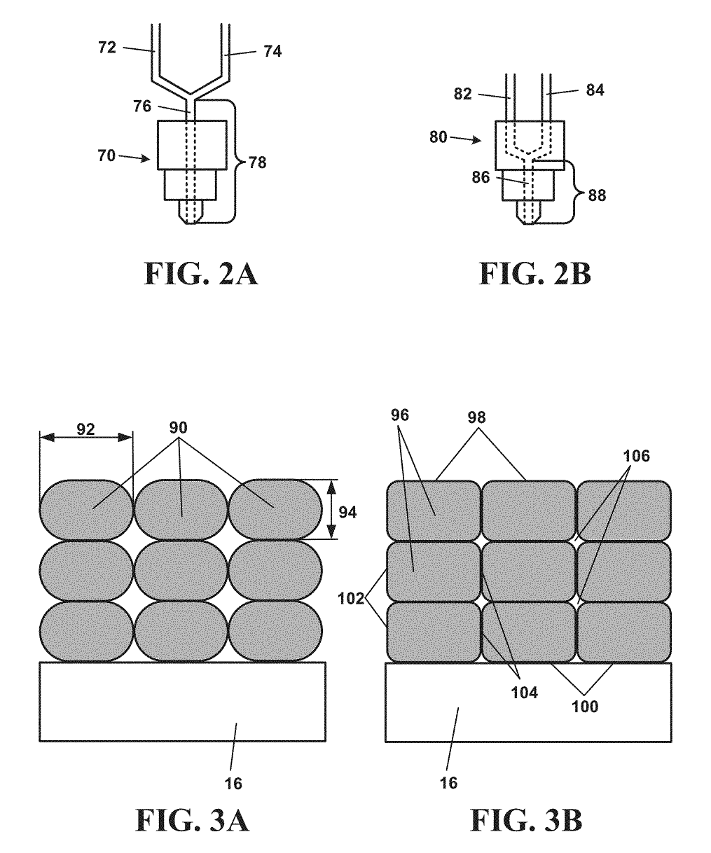

FIGS. 2A and 2B show conceptual cross sectional views of example extrusion heads with different mixing zone configurations to mix the first and second precursor solutions, for example as the build extrusion head 20 in the extrusion system 10 of FIG. 1. FIG. 2A shows an extrusion head 70 where a first precursor feed line 72 carries the first precursor solution (e.g., a bisanhydride precursor compound in solution) and a second precursor feed line 74 carries the second precursor solution (e.g., a diamine precursor compound in solution). The precursor feed lines 72, 74 can be fed by dispensers, similar to the first dispenser 46 described above. The precursor feed lines 72, 74 merge together to form a joint feed line 76 that is directed into the extrusion head 70. The joint feed line 76 provides a mixing zone 78 where the first and second precursor solutions can mix together to form a mixed precursor solution. The diameter and length of the joint feed line 76 can be selected to provide for substantially complete and uniform mixing of the first and second precursor solutions before the solutions enter the extrusion head 70, e.g., a diameter for a selected turbulence of the fluids and a length to provide sufficient distance for substantially complete and uniform mixing.

FIG. 2B shows another example extrusion head 80 with similar first and second precursor feed lines 82, 84 that can both enter the extrusion head 80. The extrusion head 80 can include a mixing chamber 86 into which the first and second polyimide precursor solutions are fed. The mixing chamber 86 includes a mixing chamber 86 for mixing the first and second precursor solutions. The feed lines 82, 84 and the mixing chamber 86 can be configured to provide for substantially complete and uniform mixing of the first and second precursor solutions before to form a mixed precursor solution that exits the mixing chamber 86 to dispense from the extrusion head 80. In some examples, a full mixing chamber may not be necessary or desired, and the precursor feed lines 82, 84 can simply merge within the extrusion head 80.

A build extrusion head, such as the extrusion head 20 in FIG. 1, the extrusion head 70 in FIG. 2A, or the extrusion head 80 in FIG. 2B, can provide for a selected cross-sectional shape of the bead extruded therefrom. The outlet opening in the nozzle of the extrusion head 20 can have a shape that corresponds to the selected cross-sectional shape of the bead 32. The polyimide precursor solution can be prepared so that it has sufficiently high viscosity such that it will substantially maintain its cross-sectional shape after extrusion. In some examples, as the polyimide precursor solution is extruded from the nozzle opening, it can have a cross-sectional shape that is substantially the same as the shape of the nozzle outlet opening. The cross-sectional shape of the bead 32 can be selected to provide for adequate contact between adjacent layers 34, 36, 38 of the extruded polyimide precursor solution to promote adhesion between adjacent beads and layers.

FIGS. 3A and 3B show cross-sectional view of example beads 90 that can form the layers 34, 36, and 38 taken along line 3-3 in FIG. 1. As shown in FIG. 3A, a bead 90 can have a substantially ovular cross-sectional shape with a longer dimension 92 of the ovular cross-section that is substantially aligned with the top surface of the substrate 16, e.g., substantially horizontal. A shorter dimension 94 of the ovular cross-section can be substantially perpendicular to the longer dimension 92, e.g., substantially vertical. The longer dimension 92 can provide for substantial contact between adjacent layers, such as the occurrent layer 34 and the immediate antecedent layer 38. Slumping of the bead 90 after extrusion can provide for contact between the bead 90 of the occurrent layer 34 and the underlying bead or beads 90 of the antecedent layer 38.

FIG. 3B shows an example bead 96 with a substantially rectangular cross-sectional shape with a substantially flat top edge 98, a substantially flat bottom edge 100, and substantially flat side edges 102, 104. The bottom edge 100 of the bead 96 forming the occurrent layer 34 can substantially abut against at least a portion of a corresponding top edge 98 of the bead 96 forming the immediate antecedent layer 38 to provide for substantial contact between the adjacent layers 34 and 38. The side edges 102, 104 can provide for substantial contact between adjacent beads 96 in the same layer 34. By providing for and maximizing contact between adjacent substantially flat top and bottom edges 98 and 100 and between adjacent substantially flat side edges 102, 104, the generally rectangular cross-section of the bead 92 can reduce or minimize porosity 106 that can form within the part due to extrusion of the polyimide precursor solution into beads 92.

Polymerization of the polyimide precursor compound can be accomplished by heating the polyimide precursor solution. Heating above a reaction polymerization temperature can initiates polymerization of the polyimide precursor compound. Heating can cause evaporation of at least a portion of the solution solvent. The temperature to which the polyimide precursor solution is heated can dictate the level of polymerization of the polyimide precursor compound, e.g., can dictate a final polymer molecular weight or range of molecular weights. If the precursor solution is heated to a first, relatively low temperature of around 50° C., the resulting polymer can be an intermediate oligomeric or moderately polymerized polyimide having a number average molecular weight of about 2000 Daltons. If the precursor solution is heated to a second, higher temperature of around 120° C., the resulting polymer can have larger polymer chains with a number average molecular weight of around 20,000 Daltons. If the precursor solution is heated to a final polymerization temperature, such as about 250° C. or about 300° C., the resulting polymer can form a substantially fully polymerized polyimide having a number average molecular weight of at least about 50,000 Daltons, such as at least about 100,000 Daltons. In some examples, the precursor solution can be heated to a first temperature to provide an intermediate polyimide polymer with a first molecular weight, then, at a later time, the intermediate polyimide polymer can be heated to a second temperature that is higher than the first, which can further polymerize the intermediate polyimide polymer to form a final polyimide polymer having a second molecular weight that is higher than the first molecular weight. Additional intermediate heating steps can be performed for various intermediate levels of polymerization (e.g., molecular weight) between the intermediate polyimide polymer and the final polyimide polymer.

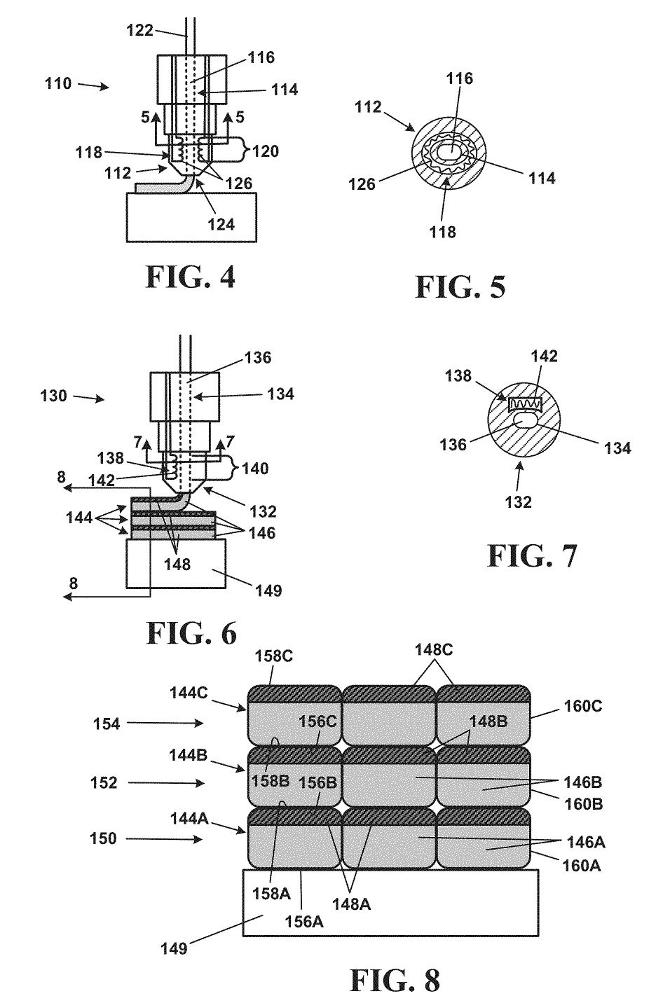

A extrusion head, such as the build extrusion head 20 of FIG. 1, can include a heating device to directly heat the precursor solution within or proximate to the extrusion head. The heater can form a heating zone within or proximate to the extrusion head to heat the polyimide precursor solution to a selected temperature in order to achieve a selected polyimide molecular weight. FIG. 4 is a cross-sectional side view of an extrusion head 110 configured to directly heat the polyimide precursor solution as it is extruded from the extrusion head 110. The example extrusion head 110 includes an extrusion nozzle 112 and a conduit 114 through which the polyimide precursor solution 116 is fed to dispense it from the extrusion nozzle 112. A heater 118 within the extrusion head 110 increases the temperature of the precursor solution 116 within a heating zone 120. The heating zone 120 can be formed inside the conduit 114. The heater 118 can heat the polyimide precursor solution at a different location, however, such as upstream of the extrusion head 110 within a feed line 122 or at or proximate to an outlet 124 of the nozzle 112. The heater 118 can include a heating element 126 or other heatable structure that can be placed in close proximity to the conduit 114. The heating element 126 can be positioned within the extrusion nozzle 112 so that the polyimide precursor solution 116 is heated substantially immediately before being dispensed from the extrusion head 110. FIG. 5 shows a cross-section taken along line 5-5 in FIG. 4 through the heating zone 120 of the extrusion head 110. As shown in FIG. 5, the heating element 126 of the heater 118 substantially surrounds the entire periphery of the conduit 114 so that the polyimide precursor solution 116 therein is substantially uniformly heated around substantially the entire periphery of the conduit 114.

FIG. 6 is a cross-sectional side view of an example extrusion head 130 configured to directly heat the polyimide precursor solution as it is extruded. The extrusion head 130 is similar to the extrusion head 110 of FIG. 4, with the extrusion head 130 being configured to non-uniformly heat the polyimide precursor. Non-uniform heating can result in the extruded bead having a non-uniform polymerization profile. For example, one portion of the cross-section of the bead can have a polymerization (e.g., average molecular weight) that is higher than that of a second portion of the cross-section. As described above, the temperature that the polyimide precursor is heated to can dictate the level of polymerization by the polyimide precursor compound. Therefore, the heating of only a portion of the polyimide precursor solution as it is extruded can result in the heated portion having a higher molecular weight than the non-heated portion.

The extrusion head 130 can include an extrusion nozzle 132 and a conduit 134 through which the polyimide precursor solution 136 is fed to dispense it from the extrusion nozzle 132. A heater 138 within the extrusion head 130 increases the temperature of a portion of the precursor solution 136 within a heating zone 140. The heating zone 140 can be formed within only a portion of the cross section of the conduit 134, so that only the polyimide precursor solution within that portion of the conduit 134 is heated. The heater 138 can be configured so that it only heats one side of the polyimide precursor solution 136 in the conduit 134. The heater 138 can include a heating element 142 or other heatable structure on that side of the conduit 134. The heating element 142 can be positioned within the extrusion nozzle 132 so that the polyimide precursor solution 136 is heated substantially immediately before being dispensed from the extrusion head 130. FIG. 7 shows a cross-section taken along line 7-7 in FIG. 6, through the heating zone 140 of the extrusion head 130. As shown in FIG. 7, the heating element 136 can be positioned at only one portion of the periphery of the conduit 134, such as on one side of the periphery, so that the polyimide precursor solution 136 is non-uniformly heated only at the portion where the heating element 136 is located. The heater 138 can take up a smaller or a larger portion of the periphery around the conduit 134. The heater 138 can include multiple heaters each taking up a partial portion of the conduit periphery at selected locations to provide for portions of the bead extruded from the extrusion head 130 having a higher polymerization compared to other portions of the bead.

The heater 138 can be positioned within the extrusion head 130 so that the heated portion of the polyimide precursor solution 136 corresponds to a top portion of the resulting bead 144. The heater 138 can be located adjacent and proximate to a long-side of the conduit 134 that corresponds to a long top side of the bead 144. By heating what will be the top of the bead 144, the bead 144 can have a lower portion 146 having a relatively low number average molecular weight and corresponding mechanical properties (e.g., a relatively low viscosity, mechanical strength, etc.) and an upper portion 148 having a relatively high number average molecular weight and corresponding mechanical properties (e.g., a relatively high viscosity, mechanical strength, etc.). The low-viscosity portion 146 can provide for better wetting between surfaces of adjacent beads 144, which can provide for better adhesion between the beads 144 when the polyimide precursor compounds are polymerized. The high-viscosity portion 148 of the bead 144 can provide for better structural stability of the bead 144 compared to a bead where the entire cross-section has a lower viscosity similar to that of the low-viscosity portion 146. The high-viscosity portion 148 can provide a relatively stable support for a subsequently-extruded bead that will be dispensed on top of the bead 144.

FIG. 8 shows a cross-sectional view of several layers formed by beads 144A, 144B, 144C extruded by the extrusion head 130 (FIGS. 6 and 7) on a substrate 149 to form a polyimide portion of an article. For example, a first layer 150 is formed by beads 144A dispensed on top of the substrate 149, a second layer 152 is formed by beads 144B dispensed on top of the first layer 150, and a third layer 154 is formed from beads 144C dispensed on top of the second layer 152. The lower viscosity portions 146A of the beads 144A of the first layer 150 include bottom surfaces 156A that abut against the substrate 149, while the higher viscosity portions 148A include top surfaces 158A. The beads 144A include side surfaces 160A that can span both the lower viscosity portions 144A and the higher viscosity portions 146A. Similarly, the higher viscosity portions 148B, 148C of the beads 144B, 144C of the second layer 152 and the third layer 154, respectively, can include top surfaces 158B, 158C. The lower viscosity portions 146B, 146C of the beads 144B, 144C can include bottom surfaces 156B, 156C that abut against the top surfaces 158A, 158B of the first layer 150 and the second layer 152, respectively. The beads 144B, 144C can include side surfaces 160B, 160C.

The higher viscosity upper portions 148 of the beads 144 can provide a relatively stable top surface 158. The lower viscosity portions 146 allows the bottom surfaces 156 of the beads 144 to more fully wet the top surfaces 158 and provide more conformal contact between adjacent beads 144, such as beads 144A and 144B. Better wetting and conformal contact can promote better adhesion between the adjacent beads 144 when the polyimide precursor compounds are polymerized. The lower viscosity lower portions 146 of the beads 144 can also make up a majority of the thickness (e.g., vertical thickness) of the beads 144 so that side surfaces 160 of adjacent beads 144 can more fully wet to provide for good contact between adjacent beads 144 in the same layer 150, 152, 154. In some examples, the wetting of the lower viscosity portions 146 can allow for at least partial intermixing between adjacent beads 144. The lower viscosity portions 146 of the beads 144 can be about 50% or more of the thickness, such as at least about 60% of the thickness, for example at least about 75%, such as at least about 80%, for example at least about 85%, such as at least about 90% of the thickness of the beads 144.

The better contact and wetting provided by the lower viscosity portions 146 of the beads 144 can provide for more molecular diffusion of the polyimide precursor compounds between beads 144 and between layers 150, 152, 154. Adhesion between adjacent beads 144, both in the same layer 150, 152, 154 and between layers 150, 152, 154, can be primarily determined by the amount of molecular diffusion that can occur between the layers 150, 152, 154 and adjacent beads 144. The non-uniform heating and resulting non-uniform viscosity of the beads 144 can provide for more complete molecular diffusion, and thus better adhesion between beads 144, resulting in parts with better mechanical properties.

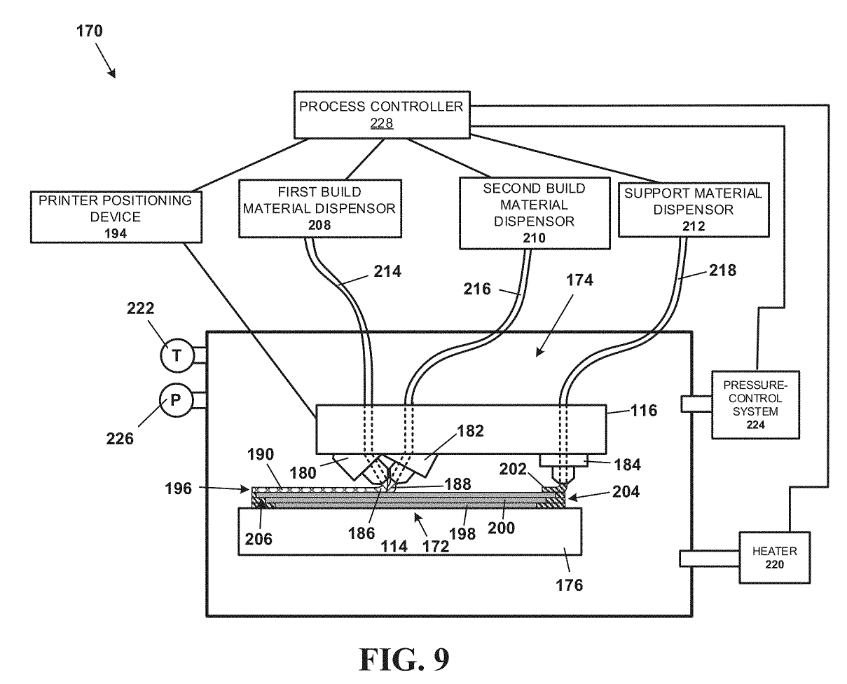

As shown above in FIG. 1, the extrusion system 10 can use a single build extrusion head 20. The system 10 can supply to the extrusion head 20 a polyimide precursor solution that includes, in a single solution, all of the polyimide precursor compounds that are selected to provide for reactive formation of the final polyimide material of the structure 12. FIG. 9 is a schematic diagram of another example extrusion printing system 170 for fabricating a structure 172 including polyimide within a build chamber 174 on a substrate 176 by selective extrusion of a polyimide precursor compound that can polymerize to form a polyimide. The extrusion system 170 can separately extrude a plurality of polyimide precursor solutions. The extrusion system 170 can extrude a first polyimide precursor solution from a first build extrusion head 180 and a second polyimide precursor solution from a second build extrusion head 182. The system 170 can include a support extrusion head 184 for selectively dispensing a support material.

The first polyimide precursor solution can comprise a first polyimide precursor compound in a first solvent, e.g., a first of a bisanhydride precursor compound and a diamine precursor compound in the first solvent, and the second polyimide precursor solution can comprise a second polyimide precursor compound in a second solvent, e.g., the other of the bisanhydride precursor compound and the diamine precursor compound in the second solvent. The first and second solvents can comprise one or both of water and an aliphatic alcohol, such as methanol or ethanol. The build extrusion heads 180, 182 can be aimed so that the first polyimide precursor solution is dispensed as a first bead 186 and the second polyimide precursor solution is dispensed as a second bead 188. The first and second beads 186, 188 can be dispensed along a common target road so that as the first precursor solution bead 186 and the second precursor solution bead 188 are dispensed they mix to form a reactive build material bead 190 of a mixed polyimide precursor solution. The polyimide precursor compounds in the reactive build material bead 190 can be polymerized, such as by heating the mixed polyimide precursor solution. Heating can initiate polymerization of the polyimide precursor compounds to form the polyimide polymer that will make up the polyimide portions of the structure 172. Heating can result in the removal of solvent from the mixed polyimide precursor solution.

The build extrusion heads 180, 182 can be any extrusion head described herein or known in the art that is capable of extruding the first and second precursor solution beads 186 and 188. For example, the build extrusion heads 180, 182 can have any one of the configurations described herein for mixing extrusion heads extrusion head 70 and 80 (FIGS. 2A and 2B or direct heating extrusion heads 110 and 130 (FIGS. 4-7).

The extrusion heads 180, 182, 184 can be configured to be moved relative to the substrate 176 along an extrusion road on top of the substrate 176 or on top of the antecedent layer or layers that have previously been built on the substrate 176. The extrusion heads 180, 182, 184 can be coupled to an head block 192 that can be moved over the substrate 176 to direct the extrusion heads 180, 182, 184 along a desired road. The head block 192 can be movable by an extrusion head actuator 194 that can move the head block 192 according to a selected coordinate system, such as Cartesian and polar coordinate systems. The actuator 194 can move the head block 192 along one or more of an X-direction 2, a Y-direction 4, and a Z-direction 6. The X-, Y-, and Z-directions 2, 4, 6, can be substantially the same as defined above with respect to FIG. 1. The extrusion heads 180, 182, 184 can be moved separately, e.g., by its own separate actuator.

The build extrusion heads 180, 182 can both be aimed at the same location, as shown in FIG. 9. In other words, when the head block 188 that carries the extrusion heads 180, 182 is stationary, the first precursor solution bead 186 will be aimed at the same target location as the second precursor solution bead 188 so that the beads 186, 188 will combine to form the reactive build material bead 190 along a combined target road. Alternatively, the build extrusion heads 180, 182 can be aimed independently and the head block 192 can be moved so that the precursor solutions can be extruded along the desired target road.

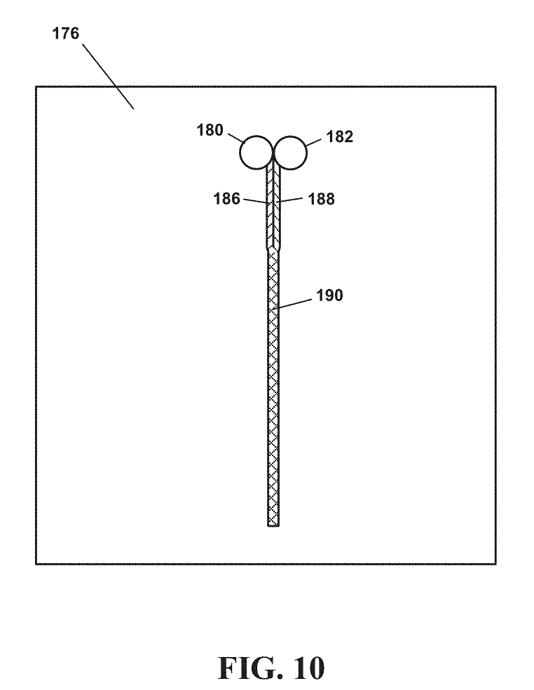

FIG. 10 shows a top view of the precursor solution beads 186, 188 being extruded by the build extrusion heads 180, 182 so that the beads 186, 188 combine and mix together to form the reactive build material bead 190. The precursor solution beads 186, 188 can be extruded along the same target road 195 so that the precursor solutions of the precursor solution beads 186, 188 mix to form the mixed precursor solution of the reactive build material bead 190. Factors such as the extrusion rate of the precursor solutions (e.g., the mass of the precursor solution extruded per minute from the extrusion heads 180, 182) and the viscosities of the precursor solutions can affect mixing of the precursor solutions to form the mixed precursor solution of the reactive build material bead 190.

The build extrusion heads 180, 182 dispense the precursor solution beads 186, 188 to provide one or more reactive build material beads 190. The one or more beads 190 can form an occurrent precursor layer 196 on top of the substrate 176 or a previously-deposited antecedent layer 198, 200. The support extrusion head 184 can dispense one or more beads 202 of the support material to form one or more support structures 204 to support overhangs 206 of the build material layers 196, 198, 200. After the structure 172 has been completed, e.g., all build material layers have been deposited, the support structures 204 can be removed, such as by dissolution with a solvent, so that only the build material layers remain in the structure 172.

The system 170 can include dispensing devices for dispensing materials to the extrusion heads 180, 182, 184. The system 170 shown in FIG. 9 includes a first dispenser 208 to dispense the first polyimide precursor solution (e.g., a solution with a bisanhydride precursor compound or a diamine precursor compound) to the first build extrusion head 180. The system 170 can include a second dispenser 210 to dispense the second polyimide precursor solution (e.g., a solution of whichever of the bisanhydride and diamine precursor compounds are not present in the first precursor solution) to the second build extrusion head 182. The system 170 can include a support material dispenser 212 to dispense the support material to the support extrusion head 184. The dispensers 208, 210, 212 can include a reservoir for storing the fluid being dispensed. The dispensers 208, 210, 212 can include a pump or other fluid displacement device for moving the fluid from the reservoir to the corresponding extrusion head 180, 182, 184. The fluids being dispensed can be fed through flexible conduits 214, 216, 218, such as flexible tubing and piping, to accommodate movement of the extrusion heads 180, 182, 184.

By separating the printing of the first polyimide precursor solution and the printing of the second polyimide precursor solution, e.g., from the first and second extrusion heads 180, 182, respectively, the system 170 can provide for easier control of the concentrations of the first and second polyimide precursor solutions. Control of these concentrations can provides for control over the composition of the resulting mixed polyimide precursor solution that forms the reactive build material bead 190, which, in turn, can provide for more control over material properties of the final polyimide polymer formed by reacting the first and second polyimide precursor compounds. Control over the composition of the final polyimide polymer can allow for some level of control over one or more physical properties of the structure 172 including polyimide. By controlling the concentration of the first polyimide precursor (e.g., a bisanhydride precursor compound) in the first precursor solution bead 186 and the concentration of the second polyimide precursor (e.g., a diamine precursor compound) in the second precursor solution bead 188, the molar ratio of the first polyimide precursor compound relative to the second polyimide precursor compound in the reactive build material bead 190 can be controlled. The volume of the precursor solution beads 186, 188 extruded onto the target road can be controlled. Variations in the molar ratio of the first and second precursors in the reactive build material bead 190 can control material properties of the resulting structure 172, including, but not limited to final molecular weight, final polymer with reactive functional groups and mechanical properties including flexural, tensile and impact.

The remainder of the system 170 shown in FIG. 9 can be substantially identical to the extrusion system 10 shown in FIG. 1. The environment in the build chamber 174 can be controlled with an environmental control system, such as a heater 220 and a temperature sensor 222 to control the temperature and a pressure-control system 224 and a pressure sensor 226 to control the pressure. One or more process controllers 228 can be provided to control operation of one or more of the components of the system 170, such as the actuator 194, the dispensers 208, 210, 212, the extrusion heads 180, 182, 184, the heater 220, and the pressure-control system 224.

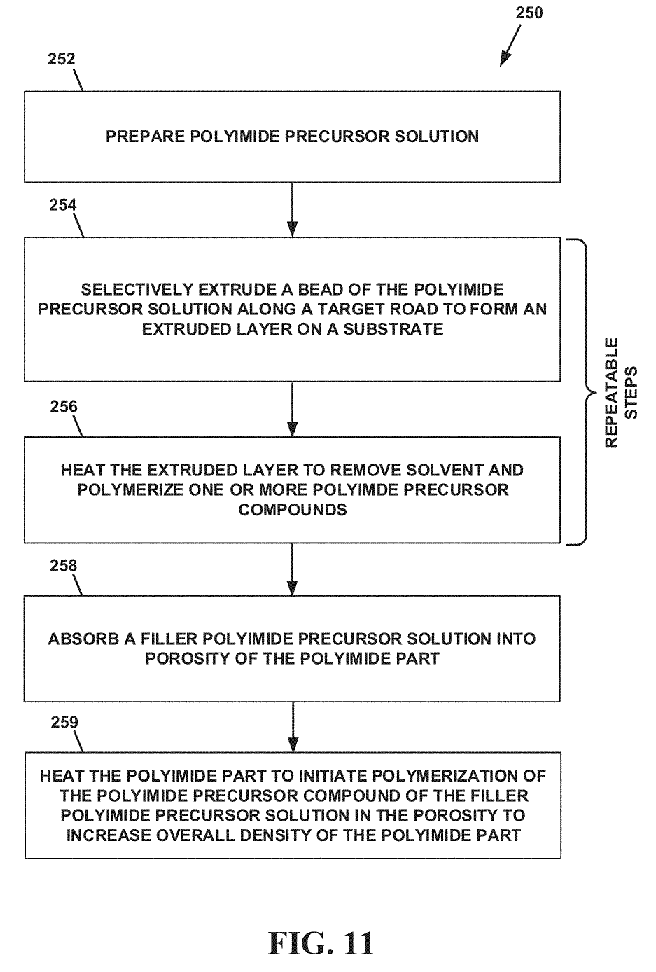

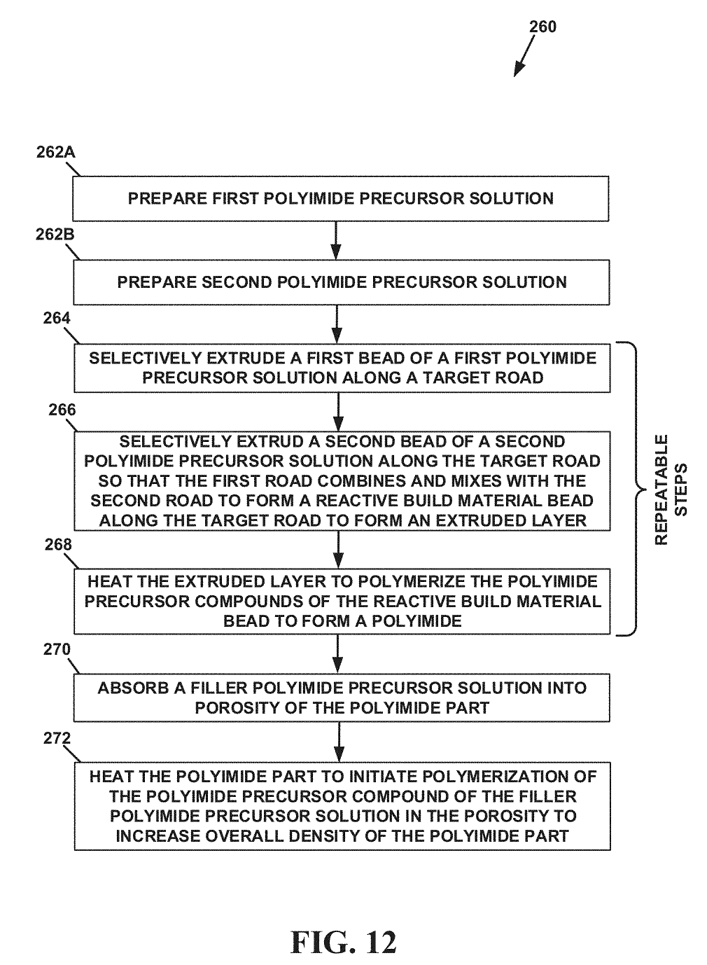

FIGS. 11 and 12 are flow diagrams of methods of material extrusion of one or more reactive polyimide precursor solutions to fabricate a polyimide part. FIG. 11 is a flow diagram of an example method 250 of extruding a precursor solution comprising a polyimide precursor compound to fabricate a structure 12 including polyimide. FIG. 12 is a flow diagram of an example method 260 of extruding a plurality of reactive polyimide precursor solutions to fabricate a structure 172 including polyimide. The methods 250, 260 will be described by referencing the systems 10 and 170 and by referencing the example extrusion heads and beads described with reference to FIGS. 2A, 2B, 3A, 3B, and 4-8, when appropriate. However, the description of the method with respect to specific structures shown in FIGS. 1, 2A, 2B, 3A, 3B, and 4-9 and described above is intended to be for illustrative purposes only, and is not meant to be limiting to the methods 260.

The method 250 of FIG. 11 can include, at 254, selectively extruding one or more beads 32 of a polyimide precursor solution onto a substrate 16. The polyimide precursor solution can comprise at least one of a bisanhydride precursor compound, a diamine precursor compound, and a reaction product of a bisanhydride precursor compound and a diamine precursor compound. The polyimide precursor solution can be extruded by a build extrusion head 20, which can be fed by a first dispenser 46 feeding the polyimide precursor solution to the build extrusion head 20 in a controlled manner.

After extruding the polyimide precursor solution as the one or more beads 32, e.g., to form a first layer 36, the extruded beads 32 can be heated, at 256, to initiate polymerization of the polyimide precursor compound in the precursor solution of the bead 32. Heating (step 256) can evaporate solvent from the solution of the extruded bead 32. Polymerization of the bisanhydride precursor compound and the diamine precursor compound can occur to form at least a portion of the structure 12, such as a first polyimide part layer.

Before extruding the polyimide precursor solution as a bead 32 (step 254), the method 250 can include, at 252, preparing the polyimide precursor solution that will be extruded. In some examples, the polyimide precursor solution can be prepared by one of three processes. A process of preparing the polyimide precursor solution (step 252) can include dissolving the bisanhydride precursor compound and the diamine precursor compound in water in the presence of a secondary or tertiary amine to provide a water-based polyimide precursor solution. Dissolving the precursor compounds in water can include first dissolving the bisanhydride precursor compound and the secondary or tertiary amine in water at a water refluxing temperature, e.g., at least about 140° C., which can be performed under pressure. The bisanhydride precursor compound can be ground into fine particles, e.g., particles having a particle size of 100 micrometers or less, in order to optimize dissolution. After dissolution of the bisanhydride precursor compound, the diamine precursor compound, such as metaphenylene diamine, can be added to the mixture and dissolved in the water. The diamine precursor compound can be added in a substantially equimolar ratio relative to the bisanhydride precursor. The water-bisanhydride-diamine solution can be kept at the water refluxing temperature for a period of time to provide for a selected level of reaction between the bisanhydride precursor compound and the diamine precursor compound to provide the polyimide precursor solution that can be extruded in step 254. The water-bisanhydride-diamine solution can be kept at the water refluxing temperature, e.g., 140° C., for at least about 1 hour, such as at least about 2 hours, to provide for a selected reaction between the precursor compounds to provide the selected polyimide precursor solution for extruding 254. A chain-stopping agent, such as pthalic anhydride, can optionally be added to the dissolved mixture of the bisanhydride precursor compound and the diamine precursor compound. The secondary or tertiary amine can comprise at least one of dimethylethanolamine and trimethylamine.

A second process of preparing the polyimide precursor solution (step 252) can include dissolving a bisanhydride precursor compound and a diamine precursor compound in an aliphatic alcohol to provide an alcohol-based polyimide precursor solution. Dissolving the precursor compounds in an aliphatic alcohol can include first dissolving the bisanhydride precursor compound in the aliphatic alcohol at an alcohol refluxing temperature, e.g., at least 100° C., which can be performed under pressure. The bisanhydride precursor compound can be ground into fine particles, e.g., particles having a particle size of 100 micrometers or less, in order to optimize dissolution. After dissolution of the bisanhydride precursor compound in the alcohol, the diamine precursor compound can be added to the mixture and dissolved in the aliphatic alcohol. The diamine precursor compound can be added in a substantially equimolar ratio relative to the bisanhydride precursor compound. The alcohol-bisanhydride-diamine solution can be kept at the alcohol refluxing temperature for a period of time to provide for a selected level of reaction between the bisanhydride precursor compound and the diamine precursor compound to provide the liquid polyimide precursor that can be extruded in step 254. The alcohol-bisanhydride-diamine solution can be kept at the alcohol refluxing temperature, e.g., at least 100° C., for at least about 1 hour, such as at least about 2 hours, to provide for a selected reaction between the precursor compounds to provide the selected polyimide precursor solution for extruding 254. The aliphatic alcohol can comprise at least one of methanol and ethanol. A chain-stopping agent, such as pthalic anhydride, can optionally be added to the dissolved bath of the bisanhydride precursor compound and the diamine precursor compound. Optionally, a secondary or tertiary amine can be added to the alcohol-dissolved mixture of the bisanhydride precursor compound and the diamine precursor compound, e.g., the alcohol-based polyimide precursor solution, to provide a water-reducible polyimide precursor solution. The secondary or tertiary amine can comprise at least one of dimethylethanolamine and trimethylamine.

A third process of preparing the polyimide precursor solution (step 252) can include dissolving a bisanhydride precursor compound and a diamine precursor compound in a mixture of water and an aliphatic alcohol to provide a precursor solution. Dissolving the precursor compounds in a water-alcohol mixture can include first dissolving the bisanhydride precursor compound in a mixture comprising the aliphatic alcohol and 50 wt. % or less water at a mixture refluxing temperature, e.g., at least 100° C., which can be performed under pressure. The bisanhydride precursor compound can be ground into fine particles, e.g., particles having a particle size of 100 micrometers or less, in order to optimize dissolution. After dissolution of the bisanhydride precursor compound in the alcohol-water mixture, the diamine precursor compound can be added to the mixture and dissolved in the alcohol-water mixture. The diamine precursor compound can be added in a substantially equimolar ratio relative to the bisanhydride precursor compounds. The alcohol-water-bisanhydride-diamine solution can be kept at the mixture refluxing temperature for a period of time to provide for a selected level of reaction between the bisanhydride and diamine precursor compounds to provide the liquid polyimide precursor that can be extruded in step 254. The alcohol-water-bisanhydride-diamine solution can be kept at the mixture refluxing temperature, e.g., 100° C., for at least about 1 hour, such as at least about 2 hours, to provide for a selected reaction between the precursor compounds to provide the selected polyimide precursor solution for extruding 254. Upon cooling to room temperature (e.g., about 23° C.), the polyimide precursor solution separates out into two fractions, a water fraction and an alcohol fraction. The fractions can be converted back to a homogeneous solution by heating below the boiling point of the aliphatic alcohol used in the formulation. The aliphatic alcohol comprises at least one of methanol and ethanol. A chain-stopping agent, such as pthalic anhydride, can optionally be added to the dissolved bath of the bisanhydride precursor compound and the diamine precursor compound.

The method 260 of FIG. 12 can include, at 264, selectively extruding a first bead 186 of a first polyimide precursor solution, for example comprising a bisanhydride precursor compound in a first solvent, along a selected target road corresponding to a portion of a structure 172 including polyimide on a substrate 176, such as with a first build extrusion head 180. The method 260 also includes, at 266, selectively extruding a second bead 188 of a second polyimide precursor solution, for example comprising a diamine precursor compound in a second solvent, along the selected target road on the substrate 176, such as with a second build extrusion head 182. The extruding of the first and second polyimide precursor solutions (steps 264 and 266) can be performed, for example, by extrusion heads 182, 184.

The first and second beads 186, 188 can combine and mix to from a reactive build material bead 190 along the selected target road on a substrate 176. The precursor solution beads 186, 188 can be extruded in any order, e.g., the first precursor solution bead 186 can be extruded first followed by the second precursor solution bead 188 or vice versa, or the first and second precursor solution beads 186, 188 can be extruded at substantially the same time.

After extruding the first and second polyimide precursor solutions to form the reactive build material bead 190, the method 260 can include, at 268, heating the one or more beads 190 to initiate polymerization of the precursor compounds in the reactive build material bead 190 into a polyimide to form the structure 172 including polyimide. The heating 268 can remove the first and second solvents (which can be the same or different solvents) from the reactive build material bead 190.

The first polyimide precursor solution can comprise a first concentration of the bisanhydride precursor compound and the second polyimide precursor solution comprises a second concentration of the diamine precursor compound. The first and second concentrations can be selected and controlled in order to provide for a selected material property for the part being printed. For example, the relative concentration of the bisanhydride precursor compound in the first polyimide precursor solution compared to that of the diamine precursor compound in the second polyimide precursor solution can be controlled to control properties of the resulting structure 172, including, but not limited to, final molecular weight, reactive functional groups of the final polymer, and mechanical properties including flexural, tensile, and impact strengths.

Before selectively extruding the first and second polyimide precursor solutions (steps 264 and 266), the method 260 can include, at 262A, preparing the first polyimide precursor solution that will form the first precursor solution bead 186 and, at 262B, preparing the second polyimide precursor solution that will form the second precursor solution bead 188. Preparing the polyimide precursor solutions can include selecting the selected ratio of the molar concentration of the bisanhydride precursor compound in the first precursor solution relative to the molar concentration of the diamine precursor compound in the second precursor solution, or a volume of the first precursor solution bead 186 relative to the volume of the second precursor solution bead 188, or both, to provide for a selected molar concentration ratio of the polyimide precursor compounds in the reactive build material bead 190 to provide a predetermined physical property of the final structure 172 including polyimide.

The first and second polyimide precursor solutions can be prepared (at steps 262A or 262B) by processes similar to those described above for step 252 in method 250 of preparing a single polyimide precursor solution. For example, the first polyimide precursor solution of a bisanhydride precursor compound can be prepared (step 262A) by dissolving the bisanhydride precursor compound in a first solvent, such as one or more of water, an aliphatic alcohol, and a mixture of water and an aliphatic alcohol, and heating the solvent and the bisanhydride precursor compound to a refluxing temperature, e.g., about 100° C. for an alcohol solvent or an alcohol and water mixture or about 140° C. for a water solvent, until dissolution of the bisanhydride precursor compound is complete. Similarly, the second polyimide precursor solution of a diamine precursor compound can be prepared (step 262B) by dissolving the diamine precursor compound in a second solvent (which can be the same or different from the first solvent), such as one or more of water, an aliphatic alcohol, and a mixture of water and an aliphatic alcohol, and heating the solvent and the diamine precursor compound to a refluxing temperature, e.g., about 100° C. for an alcohol solvent or an alcohol and water mixture or about 140° C. for a water solvent, until dissolution of the diamine precursor compound is complete. A secondary or tertiary amine, such as at least one of dimethylethanolamine and trimethylamine, can be added to the precursor solutions, for example to provide for dissolution of the precursor compounds in water or to convert an ethanol-solvent solution to a water reducible solution. Optionally, a chain-stopping agent, such as pthalic anhydride, can be added to one or both of the precursor solutions.

The one or more build material beads 32, 186, 188, 190 in the methods 250, 260 can be extruded along a selected target road corresponding to the material of a cross section of the structure 12, 172 being built. The target roads can correspond to specific points or pixels of the structure 12, 172. The target road can be identified according to 3D CAD data. The 3D CAD data can be used to control the aim of the build extrusion heads 20, 180, 182 to extrude the precursor solution along the desired target roads. The CAD data can include prepared CAD data corresponding to the location of material in a cross section of the final structure 12, 172.

The temperature to which the first extruded structures, such as the extruded layers 36, 186, 188, 190, are heated (steps 256, 268) can depend on factors such as a desired level of polymerization. The temperature of the heating in steps 256, 268 can be selected to achieve a selected molecular weight for the polymerized precursor compounds. The beads 32, 190 can be heated in steps 256, 268 to a temperature sufficient for substantially complete polymerization of the precursor compounds, e.g., to a number average molecular weight of at least about 1,000 Daltons, such as at least about 5,000 Daltons, for example at least about 10,000 Daltons, such as at least about 50,000 Daltons, for example at least about 100,000, such as 150,000 Daltons or more. In some examples, the temperature of heating in the steps 256, 268 is at least about 250° C., such as at least about to about 300° C. The temperature and duration of the heating 256, 268 can be selected depending on a selected final molecular weight of the structure 12, 172. Higher temperatures will tend to result in higher molecular weight and faster polymerization. Longer heating times will also tend to result in higher molecular weight.

The heating step 256, 268 can heat the beads 32, 190 to a first temperature that will partially polymerize the polyimide precursor compounds to a state that is sufficient to provide support to subsequently-printed layers, sometimes referred to as a B-stage polymer. In some examples, a B-stage polyimide polymer can have an intermediate number average molecular weight of from about 2,000 Daltons to about 20,000 Daltons. In some examples a B-stage polyimide polymer can be achieved by heating to an intermediate temperature of from about 50° C. to about 150° C., such as from about 60° C. to about 120° C. After all the beads 32, 190 of the structure 12, 172 have been extruded and polymerized as B-stage polymer, then the intermediate B-staged structure 12, 172 can be heated to a second temperature that is higher than the first temperature to achieve a final polymerization that is greater than the B-stage polymerization, e.g., with a final number average molecular weight of at least about 1,000 Daltons, such as at least about 5,000 Daltons, for example at least about 10,000 Daltons, such as at least about 50,000 Daltons, for example at least about 100,000, such as 150,000 Daltons or more. The temperature to polymerize the B-stage structure 12, 172 to the final polymerization can be at least about 250° C., such as from about 250° C. to about 500° C., for example at least about to about 300° C., such as from about 300° C. to about 450° C.

Heating the beads 32, 190 to a first intermediate temperature to provide for a B-stage polymer for the layers, followed by heating the full structure 12, 172 to a second final temperature for final polymerization can allow for crosslinking and/or molecular diffusion between adjacent extruded layer 34, 36, 38, 196, 198, 200. For example, a second layer 38, 200 can be extruded onto a B-staged first extruded layer 36, 198. The second extruded layer 38, 200, which comprises the liquid polyimide precursor solution, can then at least partially intermix with the B-stage polymer of the first extruded layer 36, 198, and the second extruded layer 38, 200 can be heated to the intermediate temperature to B-stage the second extruded layer 38, 200. Molecules of the polyimide precursor compound can diffuse from the beads of the second extruded layer 38, 200 to the first extruded layer 36, 198 and vice versa, due to the lower viscosity of the liquid precursor solution or the B-staged polymer. As the second extruded layer 38, 200 is heated to the intermediate temperature and polymerized to a B-stage polymer, the polymer chains can grow across the boundaries between the first extruded layer 36, 198 and the second extruded layer 38, 200 to provide at least partial cross-linking between the B-staged layers 36 and 38 or layers 198 and 200. The B-staged layers 36 and 38 or layers 198 and 200 can continue to intermix partially (e.g., because B-staged polymers can still allow for some fluid flow or diffusion, or both). Then, when the entire structure 12, 172 (or a plurality of the printed layers) is heated to the final polymerization temperature, the crosslinking across the layer boundaries can continue. The crosslinking or diffusion, or both across the layer boundaries can result in one or more of stronger interlayer strength for the part, better overall part strength, and higher part density due to partially reduced void space between adjacent layers.

The heating 256, 268 can be performed by any heater or heating method that can be reasonably applied to the printed layer of the precursor compounds, including, but not limited to, infrared (IR) heating, laser heating, injection of a hot gas into the build chamber 14, 174 (e.g., hot nitrogen or hot argon), or heating the substrate 16, 176 (e.g., with heating coils or heat exchangers). At least a portion of the heating 256, 268 can be performed by a heating device that heats the polyimide precursor solution directly while the precursor solution is being extruded, for example with a heater 118 or 138 (FIGS. 4 and 6) for directly heating the polyimide precursor solution within an extrusion head 110 or 130. The direct heating 256, 268 can be non-uniform geometric heating of the polyimide precursor solution, which can result in a non-uniform polymerization and viscosity profile of the extruded polyimide precursor solution, e.g., as a bead 144 having a low-viscosity portion 146 and a high-viscosity portion 148 (FIGS. 6 and 8).

The steps of extruding the one or more polyimide precursor solutions (steps 254 and 264) and heating the beads 32, 190 to polymerize the polyimide precursor compound (steps 256 and 268) can be repeated as many times as needed to build the structure 12, 172, such as in a layer-by-layer manner in order to build a multi-layer structure 12, 172. For example, a first layer 36, 198 can be formed on the substrate 16, 176 by selectively extruding one or more beads 32, 186, 188, 190 along a target road corresponding to the first extruded 36, 198 of the structure 12, 172 (step 254, 264). The extruded first layer 36, 198 can be heated (step 256, 268) to initiate or continue polymerization of a first polyimide precursor compound, e.g., a bisanhydride precursor compound, and the second polyimide precursor, e.g., a diamine precursor compound, respectively, or a reaction product thereof. Heating the printed extruded layer 36, 198 (step 256, 268) can be performed after the bead or beads 32, 190 have been extruded, or the heating 256, 268 can be performed continuously as the bead or beads 32, 190 are extruded to form the extruded first layer 36, 198 so that polymerization of the polyimide precursor compound can proceed as the one or more beads 32 are being extruded. The polyimide precursor solution can be prepared or extruded or partially polymerized to a state having a relatively high viscosity of at least a portion of the bead 32, 190, e.g., in a B-staged state, so that the bead 32, 190 has sufficient structural integrity to support itself and any layers that are subsequently extruded on top of the first layer 36, 198. For such a B-stage state polyimide precursor solution, the heating step 256, 268 can be performed after all layers of the structure 12, 172 have been extruded or at one or more intermediate stages after a selected number of layers have been extruded.

After printing and heating the first extruded layer 36, 198 a second extruded layer 38, 200 can be formed on top of the first extruded layer 36, 198 by selectively extruding one or more additional beads 32, 190 of the one or more polyimide precursor solutions along a target road corresponding to the second extruded layer 38, 200 (step 254, 264 repeated). The second extruded layer 38, 200 can be heated in the same way as the first extruded layer 36, 198 (step 256, 268 repeated). The heating (step 256, 268) can be performed after the extruding step 254, 264, or the build chamber 14, 174 can be substantially continuously heated as the layers 36, 38, 198, 200 are being extruded (e.g., as step 254, 264 is repeated). Successive layers can be extruded until the structure 12 including polyimide, 172 is completed. For example, these steps can be repeated for a third layer 34, 196, a fourth layer, a fifth layer, a sixth layer, and so on until the structure 12, 172 is fully formed. Support structures 42, 204 can be printed along with any layer 34, 36, 38, 196, 198, 200, to provide support for subsequently printed layers. If a single-layer structure 12, 172 is being printed, than steps 254, 364 and 256, 358 need not be repeated to form the single-layer structure 12, 172.

The structure 12 including polyimide, 172 that is formed by the repeating of steps 254, 264 and 256, 268 can result in some porosity within the part resulting from gaps between extruded beads, similar to the porosity 106 between the beads 96 shown in the example of FIG. 3B. Therefore, the methods 250, 260 can optionally include, after completing all repeat steps 254, 264 and 256, 268, at 258 or 270, absorbing a filler polyimide precursor solution into the porosity 106 of the structure 12 including polyimide, 172. The one or more polyimide precursors of the filler polyimide precursor solution can comprise at least one of a bisanhydride precursor compound, a diamine precursor compound, and a reaction production of a bisanhydride precursor compound and a diamine precursor compound. The filler polyimide precursor solution can be configured to have a viscosity that is substantially low enough to allow for substantial absorption into the porosity 106 within the structure 12, 172. The low-viscosity filler polyimide precursor solution can be absorbed into the porosity 106 of the structure 12, 172 by immersing at least a portion of the structure 12, 172 in a bath of the filler polyimide precursor solution for a period of time sufficient for a desired level of absorption into the porosity 106.

After absorbing the filler polyimide precursor solution into the porosity 106 of the structure 12, 172, the methods 250 and 260 can include, at 259 or 272 heating the structure 12 including polyimide, 172 to initiate polymerization of the polyimide precursor compound of the filler polyimide precursor solution in the porosity 106 to form a polyimide polymer within the porosity 106, which can increase overall density of the structure 12 including polyimide, 172.

The methods described herein, such as method 250 of FIG. 11 or method 260 of FIG. 12 can allow for material extrusion additive manufacturing of relatively high-molecular weight polyimide polymers, such as polyetherimide polymers. These polymers typically have too high of a molecular weight, and thus too high of a viscosity, to be effectively extruded when they are polymerized. Polyetherimides also have too high of a molecular weight to be put into a solution and extruded. The methods described herein allow for rapid prototyping of polyetherimides using material extrusion methods.

The extrusion printing systems described above with respect to FIGS. 1-10 and the methods described above with respect to FIGS. 11 and 12 can be performed using the following printing materials.

As described above, the systems and methods described herein provide for material extrusion additive manufacturing of a polyimide part. The systems and methods can use a polyimide precursor compound that can be dissolved in solvents other than harsh organic solvents to solubilize the polyimide. For example, the systems and methods described herein can form high-quality polyimide polymers via material extrusion without solvents such as tetrahydrofuran, chlorinated solvents, such as methylene chloride, chloroform, and dichlorobenzene, and solvents having a boiling point >150° C., such as N-methyl pyrrolidone, dimethyl acetamide, and dimethyl formamide. Solvents such as water and alcohol (methanol and ethanol) are preferred.

The polyimide material can be formed from one or more polyimide precursor solutions. The polyimide precursor solution can comprise a bisanhydride precursor compound and a diamine precursor compound dissolved in a solvent, or a reaction product of the bisanhydride precursor compound and the diamine precursor compound. The bisanhydride precursor compound can be dissolved in a first solvent to form a first polyimide precursor solution and the diamine precursor compound can be dissolved in a second solvent (which may be the same or different from the first solvent) to form a second polyimide precursor solution, wherein the first and second precursor solutions can be mixed together at some point to form a solution comprising both precursor compounds. An amine can also be added to the precursor solution or solutions, which can allow for effective dissolution of the precursor compounds in mild solvents, such as one or more of water, a C₁₋₆ alcohol, and a mixture of a C₁₋₆ alcohol and water. Polyimides formed from the polyimide precursor solution or solutions can be formed in the absence of a chain-stopping agent, allowing high molecular weight polyimides to be obtained. Other components, such as crosslinkers, particulate fillers, and the like can be present. The method is useful not only for layers and coatings, but also for forming composites.

The bisanhydride precursor compound can include a substituted or unsubstituted C₄₋₄₀ bisanhydride. In some examples, a bisanhydride precursor compound can have the formula (1)

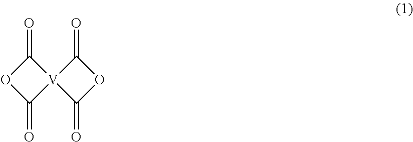

wherein V is a substituted or unsubstituted tetravalent C₄₋₄₀ hydrocarbon group, for example a substituted or unsubstituted C₆₋₂₀ aromatic hydrocarbon group, a substituted or unsubstituted, straight or branched chain, saturated or unsaturated C₂₋₂₀ aliphatic group, or a substituted or unsubstituted C₄₋₈ cycloalkylene group or a halogenated derivative thereof, in particular a substituted or unsubstituted C₆₋₂₀ aromatic hydrocarbon group. Exemplary aromatic hydrocarbon groups include, but are not limited to, any of those of the formulas

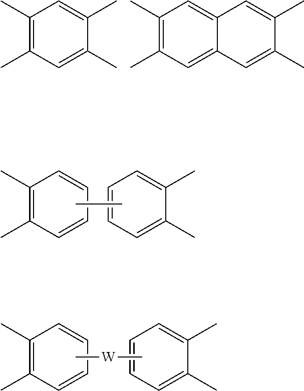

wherein W is —O—, —S—, —C(O)—, —SO₂—, —SO—, —C_{y}H_{2y}—, wherein y is an integer from 1 to 5 or a halogenated derivative thereof (which includes perfluoroalkylene groups), or a group of the formula T as described in formula (2) below.

The polyimides can include polyetherimides. Polyetherimides are prepared by the reaction of an aromatic bis(ether anhydride) of formula (2)

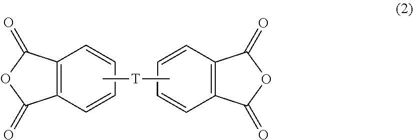

wherein T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (2) can also be a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3)

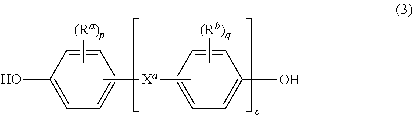

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —SO₂—, —C(O)—, or a C₁₋₁₈ organic bridging group. The C₁₋₁₈ organic bridging group can be cyclic or acyclic, aromatic or non-aromatic, and can further comprise heteroatoms such as one or more of halogens, oxygen, nitrogen, sulfur, silicon, and phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formula (3a)

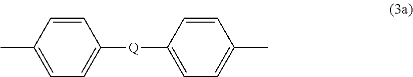

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is derived from bisphenol A, such that Q in formula (3a) is 2,2-isopropylidene.

Examples of bis(anhydride)s include, but are not limited to, 3,3-bis[4-(3,4-dicarboxyphenoxy)phenyl]propane bisanhydride; 4,4′-bis(3,4-dicarboxyphenoxy)diphenyl ether bisanhydride; 4,4′-bis(3,4-dicarboxyphenoxy)diphenyl sulfide bisanhydride; 4,4′-bis(3,4-dicarboxyphenoxy)benzophenone bisanhydride; 4,4′-bis(3,4-dicarboxyphenoxy)diphenyl sulfone bisanhydride; 2,2-bis[4-(2,3-dicarboxyphenoxy)phenyl]propane bisanhydride; 4,4′-bis(2,3-dicarboxyphenoxy)diphenyl ether bisanhydride; 4,4′-bis(2,3-dicarboxyphenoxy)diphenyl sulfide bisanhydride; 4,4′-bis(2,3-dicarboxyphenoxy)benzophenone bisanhydride; 4,4′-bis(2,3-dicarboxyphenoxy)diphenyl sulfone bisanhydride; 4-(2,3-dicarboxyphenoxy)-4′-(3,4-dicarboxyphenoxy)diphenyl-2,2-propane bisanhydride; 4-(2,3-dicarboxyphenoxy)-4′-(3,4-dicarboxyphenoxy)diphenyl ether bisanhydride; 4-(2,3-dicarboxyphenoxy)-4′-(3,4-dicarboxyphenoxy)diphenyl sulfide bisanhydride; 4-(2,3-dicarboxyphenoxy)-4′-(3,4-dicarboxyphenoxy)benzophenone bisanhydride; and, 4-(2,3-dicarboxyphenoxy)-4′-(3,4-dicarboxyphenoxy)diphenyl sulfone bisanhydride, as well as various combinations thereof.

In some examples, the diamine precursor compound can comprise a diamine having the general formula (4)

H₂N—R—NH₂ (4)

wherein R is a substituted or unsubstituted divalent C₁₋₂₀ hydrocarbon group, such as a substituted or unsubstituted C₆₋₂₀ aromatic hydrocarbon group or a halogenated derivative thereof, a substituted or unsubstituted, straight or branched chain, saturated or unsaturated C₂₋₂₀ alkylene group or a halogenated derivative thereof, a substituted or unsubstituted C₃₋₈ cycloalkylene group or halogenated derivative thereof, in particular one of the divalent groups of formula (5)

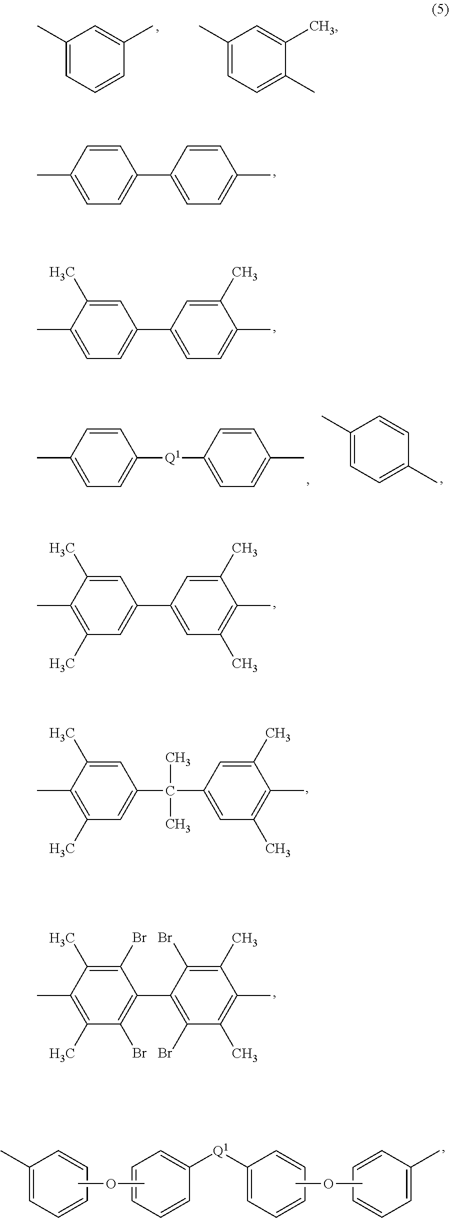

wherein Q¹ is —O—, —S—, —C(O)—, —SO₂—, —SO—, —C_{y}H_{2y}— wherein y is an integer from 1 to 5 or a halogenated derivative thereof (which includes perfluoroalkylene groups), or —(C₆H₁₀)_{z}— wherein z is an integer from 1 to 4. In some examples R is m-phenylene, p-phenylene, or 4,4′-diphenylene sulfone. In some embodiments, no R groups contain sulfone groups. In another embodiment, at least 10 mol % of the R groups contain sulfone groups, for example 10 to 80 wt. % of the R groups contain sulfone groups, in particular 4,4′-diphenylene sulfone groups.

Examples of organic diamines include, but are not limited to, ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis(3-aminopropyl)amine, 3-methoxyhexamethylenediamine, 1,2-bis(3-aminopropoxy)ethane, bis(3-aminopropyl)sulfide, 1,4-cyclohexanediamine, bis-(4-aminocyclohexyl)methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylenediamine, 5-methyl-4,6-diethyl-1,3-phenylenediamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, and bis(4-aminophenyl) ether. Combinations of these compounds can also be used. In some embodiments the organic diamine is m-phenylenediamine, p-phenylenediamine, 4,4′-sulfonyl dianiline, or a combination comprising one or more of the foregoing.

In some embodiments, the one or more aromatic bisanhydride precursor compounds of formula (1) or (2) can be reacted with a diamine precursor compound comprising an organic diamine (4) as described above or a mixture of diamines, and a polysiloxane diamine of formula (6)

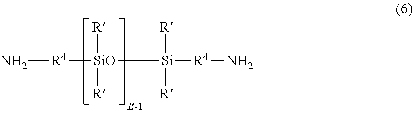

wherein each R′ is independently a C₁₋₁₃ monovalent hydrocarbyl group. For example, each R′ can independently be a C₁₋₁₃ alkyl group, C₁₋₁₃ alkoxy group, C₂₋₁₃ alkenyl group, C₂₋₁₃ alkenyloxy group, C₃₋₆ cycloalkyl group, C₃₋₆ cycloalkoxy group, C₆₋₁₄ aryl group, C₆₋₁₀ aryloxy group, C₇₋₁₃ arylalkyl group, C₇₋₁₃ arylalkoxy group, C₇₋₁₃ alkylaryl group, or C₇₋₁₃ alkylaryloxy group. The foregoing groups can be fully or partially halogenated with fluorine, chlorine, bromine, or iodine, or a combination comprising at least one of the foregoing. In some examples no halogens are present. Combinations of the foregoing R′ groups can be used in the same copolymer. In some examples, the polysiloxane diamine comprises R′ groups that have minimal hydrocarbon content, e.g., a methyl group.

E in formula (6) has an average value of 5 to 100, and each R⁴ is independently a C₂-C₂₀ hydrocarbon, in particular a C₂-C₂₀ arylene, alkylene, or arylenealkylene group. In some examples R⁴ is a C₂-C₂₀ alkyl group, specifically a C₂-C₂₀ alkyl group such as propylene, and E has an average value of 5 to 100, 5 to 75, 5 to 60, 5 to 15, or 15 to 40. Procedures for making the polysiloxane diamines of formula (6) are well known in the art.

The diamine component can contain 10 to 90 mole percent (mol %), or 20 to 50 mol %, or 25 to 40 mol % of polysiloxane diamine (5) and 10 to 90 mol %, or 50 to 80 mol %, or 60 to 75 mol % of diamine (4). The diamine components can be physically mixed prior to reaction with the bisanhydride(s), thus forming a substantially random copolymer. Block or alternating copolymers can be formed by selective reaction of (4) and (6) with aromatic bis(ether anhydride)s (1) or (2), to make polyimide blocks that are subsequently reacted together. Thus, the polyimide-siloxane copolymer can be a block, random, or graft copolymer.

A polyimide precursor solution can be prepared for extruding in order to form a polyimide part. For example, the extruded bead 32 in the example extrusion system 10 of FIG. 1 and the example method 250 of FIG. 11 can comprise a polyimide precursor solution. The polyimide precursor solution can comprise a polyimide prepolymer and a solvent, such as a solvent comprising a C₁₋₆ alcohol. The polyimide precursor solution can also include an amine to effectively solubilize the polyimide prepolymer in the alcohol solvent, in a mixture of an alcohol solvent and water, or in water.

The polyimide prepolymer in the polyimide precursor solution can be a reaction product of the bisanhydride precursor compound and the diamine precursor compound described above, such as a reaction product between a substituted or unsubstituted C₄₋₄₀ bisanhydride and a substituted or unsubstituted divalent C₁₋₂₀ diamine. The polyimide precursor can comprise more than 1, for example 10 to 1000, or 10 to 500, structural units of formula (7)

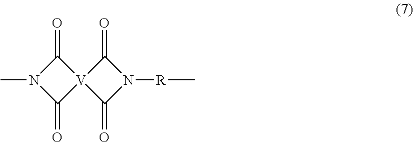

wherein each V is the same or different, and is as described in formula (1), and each R is the same or different, and is defined as in formula (4). The polyetherimides comprise more than 1, for example 10 to 1000, or 10 to 500, structural units of formula (8)

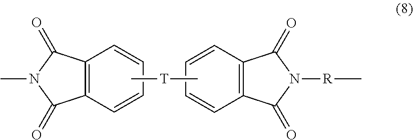

wherein each T is the same or different, and is as described in formula (2), and each R is the same or different, and is as described in formula (4), preferably m-phenylene or p-phenylene.

The polyetherimides can optionally further comprises up to 10 mole %, up to 5 mole %, or up to 2 mole % of units of formula (8) wherein T is a linker of the formula (9)

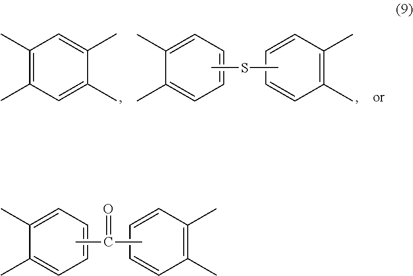

In some embodiments no units are present wherein R is of these formulas.

In some examples in formula (1), R is m-phenylene or p-phenylene and T is —O—Z—O— wherein Z is a divalent group of formula (3a). Alternatively, R is m-phenylene or p-phenylene and T is —O—Z—O wherein Z is a divalent group of formula (3a) and Q is 2,2-isopropylidene.

In some examples, the polyetherimide can be a polyetherimide sulfone. For example, the polyetherimide can comprise the etherimide units wherein at least 10 mole percent, for example 10 to 90 mole percent, 10 to 80 mole percent, 20 to 70 mole percent, or 20 to 60 mole percent of the R groups comprise a sulfone group. For example, R can be 4,4′-diphenylene sulfone, and Z can be 4,4′-diphenylene isopropylidene, providing units of formula (10).

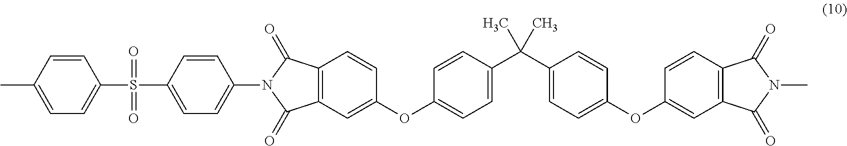

In another embodiment the polyetherimide can be a polyetherimide-siloxane block or graft copolymer. Block polyimide-siloxane copolymers comprise imide units and siloxane blocks in the polymer backbone. Block polyetherimide-siloxane copolymers comprise etherimide units and siloxane blocks in the polymer backbone. The imide or etherimide units and the siloxane blocks can be present in random order, as blocks (i.e., AABB), alternating (i.e., ABAB), or a combination thereof. Graft copolymers are non-linear copolymers comprising the siloxane blocks connected to a linear or branched polymer backbone comprising imide or etherimide blocks.

In some examples, a polyetherimide-siloxane has units of the formula

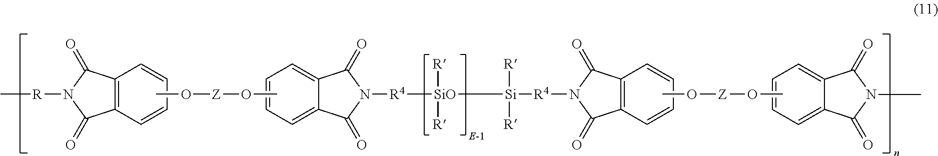

wherein R′, R⁴, and E of the siloxane are as in formula (6), R is as in formula (4), Z is as in formula (2), and n is an integer from 5 to 100. In a specific embodiment, the R of the etherimide is a phenylene, Z is a residue of bisphenol A, R⁴ is n-propylene, E is 2 to 50, 5, to 30, or 10 to 40, n is 5 to 100, and each R′ of the siloxane is methyl. In some examples the polyetherimide-siloxane comprises 10 to 50 weight %, 10 to 40 weight %, or 20 to 35 weight % polysiloxane units, based on the total weight of the polyetherimide-siloxane.

The polyimide prepolymer can comprise partially reacted units of formulas q and r to fully reacted units of formula s.

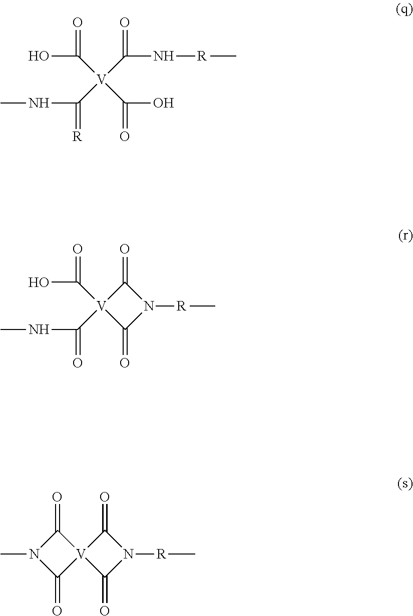

wherein V and R are as defined above. The polyimide prepolymer contains at least one unit (q), 0 or 1 or more units (r), and 0 or 1 or more units (s), for example 1 to 200 or 1 to 100 units q, 0 to 200 or 0 to 100 units (r), or 0 to 200 or 0 to 100 units (s). An imidization value for the polyimide prepolymer can be determined using the relationship

(2s+r)/(2q+2r+2s)

Wherein q, r, and s stand for the number of units (q), (r), and (s), respectively. In some embodiments, the imidization value of the polyimide prepolymer is less than or equal to 0.2, less than or equal to 0.15, or less than or equal to 0.1. In some embodiments, the polyimide prepolymer has an imidization value of greater than 0.2, for example greater than 0.25, greater than 0.3, or greater than 0.5, provided that the desired solubility of the polyimide prepolymer is maintained. The number of units if each type can be determined by spectroscopic methods, for example FT-IR.

The polyimide precursor solution can further include an amine. The amine can comprise a secondary amine, a tertiary amine, or a combination comprising at least one of the foregoing. In some embodiments, the amine preferably comprises a tertiary amine.

The amine can be selected such that less than or equal to 0.5 grams of the amine is effective to solubilize 1 gram of the polyimide prepolymer in deionized water.

In some embodiments, the amine is a secondary or a tertiary amine of the formula (12)

R^{A}R^{B}R^{C}N (12)

wherein R^{A}, R^{B}, and R^{C} can be the same or different and are a substituted or unsubstituted C₁₋₁₈ hydrocarbyl or hydrogen, provided that no more than one of R^{A}, R^{B}, and R^{C} are hydrogen. R^{A}, R^{B}, and R^{C} can be the same or different and can be a substituted or unsubstituted C₁₋₁₂ alkyl, a substituted or unsubstituted C₁₋₁₂ aryl, or hydrogen, provided that no more than one of R^{A}, R^{B}, and R^{C} are hydrogen. R^{A}, R^{B}, and R^{C} can be the same or different and can be an unsubstituted C₁₋₆ alkyl or a C₁₋₆ alkyl substituted with 1, 2, or 3 hydroxyl, halogen, nitrile, nitro, cyano, C₁₋₆ alkoxy, or amino groups of the formula —NR^{D}R^{E} wherein R^{D} and R^{E} are the same or different and can be a C₁₋₆ alkyl or C₁₋₆ alkoxy. R^{A}, R^{B}, and R^{C} can be the same or different and can be an unsubstituted C₁₋₄ alkyl or a C₁₋₄ alkyl substituted with one hydroxyl, halogen, nitrile, nitro, cyano, or C₁₋₃ alkoxy.

In some embodiments, the amine comprises triethylamine, trimethylamine, dimethylethanolamine, diethanolamine, or a combination comprising at least one of the foregoing. For example, the amine comprises triethylamine. For example, the amine comprises dimethylethanolamine. For example, the amine comprises diethanolamine.

The amine can be added to the polyimide precursor solution in an amount effective to solubilize the polyimide prepolymer in a C₁₋₆ alcohol, in a solution of the C₁₋₆ alcohol and deionized water, or in deionized water. For example, the amine can be present in the polyimide precursor solution in an amount of 5 to 50 wt. %, or 8 to 40 wt. %, or 9 to 35 wt. %, based on the combined weight of the amine and the dry weight of the polyimide prepolymer.

The amine can be added in an amount effective to solubilize the polyimide prepolymer in the alcohol, the mixture of the alcohol and water, or in water. In some examples, the solution can be heated at a temperature equal to the boiling point of the C₁₋₆ alcohol at atmospheric pressure, or at a temperature greater than 100° C. at a pressure greater than atmospheric pressure.

The polyimide precursor solution includes a solvent, e.g., for the dissolution of at least one of the bisanhydride precursor compound, the diamine precursor compound, and the polyimide prepolymer. The solvent can be a protic organic solvent. Examples of protic organic solvents include, but are not limited to, a C₁₋₆ alcohol, wherein the C₁₋₆ alkyl group can be linear or branched. The C₁₋₆ alcohol can include methanol, ethanol, n-propanol, isopropanol, n-butanol, t-butanol, sec-butanol, 1-pentanol, 2-pentanol, 3-pentanol, 1-hexanol, 2-hexanol, 3-hexanol, 2-ethyl-1-butanol, 3-methyl-1-butanol, 3-methyl-2-butanol, 2-methyl-2-butanol, 2,2-dimethyl-1-propanol, ethylene glycol, diethylene glycol, or a combination comprising at least one of the foregoing. In some embodiments, the C₁₋₆ alcohol is substantially miscible with water. For example the C₁₋₆ alcohol can comprise methanol, ethanol, n-propanol, isopropanol, or a combination comprising at least one of the foregoing. In some examples, the solvent comprises methanol, ethanol, or a combination comprising at least one of the foregoing.

In some embodiments, the solvent further comprises water, for example deionized water. The solvent can include water in a weight ratio of C₁₋₆ alcohol:water of about 1:100 to about 100:1, such as about 1:10 to about 10:1, for example about 1:2 to about 2:1, such as about 1:1.1 to about 1.1:1. In other embodiments, however, no water is present. For example, the solvent can comprise less than 1 weight percent (wt. %), or is devoid of water. Similarly, the solvent can comprise no alcohol and can be substantially entirely water, e.g., less than 1 wt. % alcohol.

The solvent can comprise less than 1 wt. %, or is devoid of harsher organic solvents, such as one or more of chlorobenzene, dichlorobenzene, cresol, dimethyl acetamide, veratrole, pyridine, nitrobenzene, methyl benzoate, benzonitrile, acetophenone, n-butyl acetate, 2-ethoxyethanol, 2-n-butoxyethanol, dimethyl sulfoxide, anisole, cyclopentanone, gamma-butyrolactone, N,N-dimethyl formamide, N-methyl pyrrolidone, tetrahydrofuran, and combinations thereof. In another embodiment, the solvent comprises less than 1 wt. %, or less than 0.1 wt. % of a nonprotic organic solvent, and in some examples the solvent is devoid of a nonprotic organic solvent. In another embodiment, the solvent comprises less than 1 wt. %, or less than 0.1 wt. %, of a halogenated solvent, and preferably the solvent is devoid of a halogenated solvent.

The polyimide precursor solution can comprise, based on the total weight of the compositions: from about 1 to about 90 wt. % of the polyimide prepolymer, such as from about 5 to about 80 wt. %, for example from about 10 to about 70 wt. % of the polyimide prepolymer; from about 10 to 99 wt. % of the solvent, such as from about 20 to about 95 wt. %, for example from about 30 to about 90 wt. % of the solvent; and from about 0 wt/% or about 0.001 wt. % to about 50 wt. % of the amine, such as from about 0.01 to about 30 wt. %, for example from about 0.01 to about 15 wt. % of the amine.

As noted above, the polyimide precursor solution that is capable of forming polyimide polymer parts via material extrusion printing can be formed using solvents other than harsh organic solvents, including tetrahydrofuran, chlorinated solvents, such as methylene chloride, chloroform, and dichlorobenzene, and solvents having a boiling point >150° C., such as N-methyl pyrrolidone, dimethyl acetamide, and dimethyl formamide.

The polyimide precursor solution can further comprise additional components to modify the reactivity or processability of the compositions, or properties of the polyimides and articles formed from the polyimides. For example, the polyimide precursor solution can further comprise a polyimide chain-stopping agent to adjust the molecular weight of the polyimide. Examples of chain-stopping agents include, but are not limited to, monofunctional amines such as aniline and mono-functional anhydrides such as phthalic anhydride, maleic anhydride, and nadic anhydride. The chain-stopping agent can be present in an amount of 0.2 mole percent to 10 mole percent, more preferably 1 mole percent to 5 mole percent based on total moles of one of the bisanhydride precursor compound or the diamine precursor compound. In some examples, the polyimide prepolymer is partially endcapped with a chain-stopping agent. In another embodiment, however, no chain-stopping agent is present in the polyimide precursor solution.

In another embodiment, the polyimide precursor solution can further comprise a polyimide crosslinking agent. Such crosslinking agents are known, and include, compounds containing an amino group or an anhydride group and crosslinkable functionality, for example ethylenic unsaturation. Examples include, but are not limited to, maleic anhydride and benzophenone tetracarboxylic acid anhydride. The crosslinking agents can be present in an amount of 0.2 mole percent to 10 mole percent, more preferably 1 mole percent to 5 mole percent based on total moles of one of the bisanhydride or diamine precursor compounds.

The polyimide precursor solution can further comprise a branching agent, for example a polyfunctional organic compound having at least three functional groups which can be, for example, amine, carboxylic acid, carboxylic acid halide, carboxylic anhydride, and mixtures thereof. A branching agent can be a substituted or unsubstituted polyfunctional C₁₋₂₀ hydrocarbon group having at least three of any one or more of the aforementioned functional groups. Exemplary branching agents can include a C₂₋₂₀ alkyltriamine, a C₂₋₂₀ alkyltetramine, a C₆₋₂₀ aryltriamine, an oxyalkyltriamine (e.g., JEFFAMINE T-403™ available from Texaco Company), trimellitic acid, trimellitic anhydride, trimellitic trichloride, and the like, and combinations comprising at least one of the foregoing. When present, the amount of branching agent can be 0.5 to 10 weight percent based on the weight of the polyimide prepolymer.

The polyimide precursor solution can further comprise a particulate polymer dispersible in the solvent, for example dispersible in the C₁₋₆ alcohol, in a solution of the C₁₋₆ alcohol and water, or in water. In some examples, the particulate polymers are preferably dispersible in water. Imidization of the polyimide prepolymer in the presence of the particulate polymer can provide an intimate blend of the polymer and the polyimide. The dispersible polymers can have an average particle diameter from 0.01 to 250 micrometers. Aqueous-dispersible polymers include, but are not limited to, fluoropolymers, (e.g., polytetrafluoroethylene, tetrafluoroethylene-perfluoroalkylvinylether copolymer, tetrafluoroethylene-hexafluoropropylene copolymer, polychlorotrifluoroethylene, tetrafluoroethylene-ethylene copolymer, polyvinylidene fluoride), (meth)acrylic and (meth)acrylate polymers (e.g., poly(methyl (meth)acrylate), poly(ethyl (meth)acrylate), poly(n-butyl (meth)acrylate), poly(2-ethyl hexyl (meth)acrylate), copolymers thereof, and the like), styrenic polymers (e.g., polystyrene, and copolymers of styrene-butadiene, styrene-isoprene, styrene-acrylate esters, and styrene-acrylonitrile), vinyl ester polymers (e.g., poly(vinyl acetate), poly(vinyl acetate-ethylene) copolymers, poly(vinyl proprionate), poly(vinyl versatate) and the like), vinyl chloride polymers, polyolefins (e.g., polyethylenes, polyproplyenes, polybutadienes, copolymers thereof, and the like), polyurethanes, polyesters (e.g., poly(ethylene terephthalate), poly(butylene terephthalate), poly(caprolactone), copolymers thereof, and the like), polyamides, natural polymers such as polysaccharides, or a combination comprising at least one of the foregoing.

When present, the dispersible polymers can be present in an amount of 0.1 to 50 wt. %, preferably 1 to 30 wt. %, more preferably from 5 to 20 wt. %, based on the total weight of the precursor compounds in the composition.

The polyimide precursor solution can further comprise additives for polyimide compositions known in the art, with the proviso that the additive(s) are selected so as to not significantly adversely affect the desired properties of the compositions, in particular formation of the polyimide. Such additives include a particulate filler (such as glass, carbon, mineral, and metal), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. In general, the additives are used in the amounts generally known to be effective. For example, the total amount of the additive composition can be 0.001 to 10.0 wt. %, or 0.01 to 5 wt. %, based on the total weight of the precursor compounds in the composition.

For example, a combination of a heat stabilizer, mold release agent, and ultraviolet light stabilizer can be used. Pigments, surface effect agents, and nanosized fillers are also specifically contemplated, as such materials can be readily co-dispersed with precursor compounds, or pre-combined with the precursor compounds. When present, the nanosized fillers can be present in an amount of 0.1 to 50 wt. %, preferably 1 to 30 wt. %, more preferably from 2 to 10 wt. %, based on the total weight of the precursor compounds in the composition.

The polyimide precursor solution can be used in the formation of a polyimide part, for example by extrusion from the extrusion system 10 or the method 250. The precursor compounds (e.g., the bisanhydride precursor compound solution and the diamine precursor compound solution) can be dissolved into separate polyimide precursor solutions and extruded separately so that the precursor solutions mix together to form the polyimide precursor solution, as in the system 170 and method 260.

The extruded polyimide precursor solution can be converted to a polyimide part by heating the part at a temperature and for a period of time effective to imidize the polyimide prepolymer and form the polyimide. Suitable temperatures are greater than or equal to about 250° C., such as from about 250 to about 500° C., for example from about 300 to about 450° C. The polyimide precursor solution can be heated for a time from 10 minutes to 3 hours, such as from 15 minutes to 1 hour. The imidization can be conducted under an inert gas during the heating. Examples of inert gasses that can be used include, but are not limited to, dry nitrogen, helium, argon and the like. Dry nitrogen is generally preferred. In an advantageous feature, such blanketing is not required. The imidization is generally conducted at atmospheric pressure.

The solvent to be removed from the extruded polyimide precursor solution during the imidization, or the solvent can be removed from the extruded polyimide precursor solution before the imidization, for example by heating to a temperature below the imidization temperature. The solvent can be partially removed, or can be fully removed.

If a crosslinker is present in the polyimide precursor solution, crosslinking can occur before the imidization, during the imidization, or after the imidization. For example, when the crosslinker comprises ethylenically unsaturated groups, the printed polyimide precursor solution can be crosslinked by exposure to ultraviolet (UV) light, electron beam radiation or the like, to stabilize the extruded polyimide precursor solution. The polyimide can be post-crosslinked to provide additional strength or other properties to the polyimide.

Depending on the precursor compounds and other materials used in the polyimide precursor solution, the polyimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyimide has a weight average molecular weight (MW) of greater than 1,000 grams/mole (Daltons), or greater than 5,000 Daltons, or greater than 10,000 Daltons, or greater than 50,000 Daltons, or greater than 100,000 Daltons as measured by gel permeation chromatography, using polystyrene standards. For example, the polyimide can have a weight average molecular weight (MW) of 1,000 to 150,000 Daltons. In some embodiments the polyimide has a MW of 10,000 to 80,000 Daltons, specifically greater than 10,000 Daltons or greater than 60,000 Daltons, up to 100,000 or 150,000 Daltons. In some embodiments, the polyimide has a molecular weight that is no more than 10% lower than the molecular weight of the same polyimide formed in the absence of the amine. The polyimides can further have a polydispersity index of 2.0 to 3.0, or 2.3 to 3.0.

The polyimides can further be characterized by the presence of less than 1 wt. %, or less than 0.1 wt. % of a nonprotic organic solvent. In some examples, it is preferred that the polyimide is devoid of a nonprotic organic solvent. Similarly, the polyimide has less than 1 wt. %, or less than 0.1 wt. % of a halogenated solvent, and preferably the polyimide is devoid of a halogenated solvent. Such properties are particularly useful in layers or conformal coatings having a thickness from 0.1 to 1500 micrometers, specifically 1 to 500 micrometers, more specifically 5 to 100 micrometers, and even more specifically 10 to 50 micrometers.

The methods of manufacturing polyimides and articles comprising the polyimides described herein do not rely on organic solvents, and allow for very small extruded beads (e.g., the precursor solution bead 32 or precursor solution beads 186, 188), which can allow for thin layers of the polyimide to be obtained. The method is useful not only for layers and coatings, but also for forming composites. Therefore, a substantial improvement in methods of manufacturing polyimides and articles prepared therefrom is provided.

Set forth below are some embodiments of the methods and systems disclosed herein.

### Embodiment 1

A system for fabricating an article, the system comprising: an extrusion head configured to selectively extrude a bead of a precursor solution (preferably at least two precursor solutions) onto a target road (preferably at least two target roads) on a substrate within a build area, the precursor solution comprising a polyimide precursor compound (preferably at least two polyimide precursor compounds) in a solvent; an extrusion head actuator coupled to the extrusion head to move the extrusion head; a control system coupled to the extrusion head actuator to control the extrusion head actuator to control the extrusion head along a target road (preferably at least two target roads) and selectively dispense the precursor solution to the extrusion head; and an environmental system configured to accommodate the target road during fabrication of the article, the environmental system configured to expose the dispensed precursor solution to a temperature selected to evaporate solvent from the solution to initiate polymerization of the polyimide precursor compound to form at least a portion of a polyimide part.

### Embodiment 2

The system according to Embodiment 1, wherein the polyimide precursor compound comprise at least one of a bisanhydride precursor compound, a diamine precursor compound, and a reaction product of a bisanhydride precursor compound and a diamine precursor compound.

### Embodiment 3

The system according to Embodiment 2, wherein the reaction product is formed by a process comprising one of: dissolving the bisanhydride precursor compound and the diamine precursor compound in water in the presence of a secondary or tertiary amine to provide the precursor solution; dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the precursor solution; or dissolving the bisanhydride precursor compound and the diamine precursor compound in a mixture of water and an aliphatic alcohol to provide the precursor solution.

### Embodiment 4

The system according to Embodiment 3, wherein the bisanhydride precursor compound and the diamine precursor compound are dissolved in a substantially equimolar ratio.

### Embodiment 5

The system according to any one of Embodiments 1-4, wherein the solvent comprises at least one of water and an aliphatic alcohol.

### Embodiment 6

The system according to any one of Embodiments 1-5, wherein the extrusion head comprising a heater to heat the precursor solution to a polymerization temperature as the precursor solution is extruded from the extrusion head.

### Embodiment 7

The system according to Embodiment 6, wherein the extrusion head comprises an extrusion nozzle through which the precursor solution is extruded, wherein the heater heats at least a portion of the extrusion nozzle to preheat the precursor solution.

### Embodiment 8

The system according to Embodiment 7, wherein the heated portion of the nozzle comprises a non-uniform portion of a perimeter of the extrusion nozzle.

### Embodiment 9

The system according to any one of Embodiments 1-8, wherein the precursor solution comprises a first one of a bisanhydride precursor compound and a diamine precursor compound in a first solvent, the system further comprising a second extrusion head configured to selectively extrude a bead of a second precursor solution onto the target road within a build area, the second precursor solution comprising a second one of the bisanhydride precursor compound and the diamine precursor compound in a second solvent.

### Embodiment 10

The system according to any one of Embodiments 1-9, further comprising: a first dispenser configured to dispense a first polyimide precursor to the extrusion head, the first polyimide precursor comprising a bisanhydride precursor compound in a first solvent; and a second dispenser configured to dispense a second polyimide precursor to the extrusion head, the second polyimide precursor comprising a diamine precursor compound in a second solvent; wherein the extrusion head comprises a mixing zone to mix the first polyimide precursor and the second polyimide precursor to form the precursor solution prior to extrude the bead of the precursor solution onto the target road on the substrate within the build area.

### Embodiment 11

The system according to any one of Embodiments 1-10, wherein the extruded bead of precursor solution has a cross-sectional shape with substantially top, bottom, and side edges.

### Embodiment 12

A method of fabricating a part, the method comprising:

selectively extruding a bead of a precursor solution onto a target road on a substrate, the precursor solution comprising a polyimide precursor compound in a solvent; and heating the extruded bead of precursor solution to initiate polymerization of the polyimide precursor compound into a structure including polyimide.

### Embodiment 13

The method according to Embodiment 12, wherein the polyimide precursor comprises at least one of a bisanhydride precursor compound, a diamine precursor compound, and a reaction product of a bisanhydride precursor compound and a diamine precursor compound.

### Embodiment 14

The method according to Embodiment 13, further comprising preparing the precursor solution by a process comprising one of: dissolving the bisanhydride precursor compound and the diamine precursor compound in water in the presence of a secondary or tertiary amine to provide the precursor solution; dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the precursor solution; or dissolving the bisanhydride precursor compound and the diamine precursor compound in a mixture of water and an aliphatic alcohol to provide the precursor solution.

### Embodiment 15

The method according to Embodiment 14, wherein the bisanhydride precursor compound and the diamine precursor compound are dissolved in a substantially equimolar ratio.

### Embodiment 16

The method according to any one of Embodiments 12-15, wherein selectively extruding the bead of the precursor solution is performed with an extrusion head, the method further comprising preheating the precursor solution to a polymerization temperature at the extrusion head.

### Embodiment 17

The method according to Embodiment 16, wherein preheating the precursor solution at the extrusion head comprises heating a non-uniform portion of a perimeter of the extruded bead of precursor solution.

### Embodiment 18

The method according to any one of Embodiments 12-17, wherein the precursor solution comprises a first one of a bisanhydride precursor compound and a diamine precursor compound in a first solvent, the method further comprising selectively extruding a bead of a second precursor solution onto the target road within a build area, the second precursor solution comprising a second one of the bisanhydride precursor compound and the diamine precursor compound in a second solvent.

### Embodiment 19

The method according to any one of Embodiments 12-18, wherein selectively extruding the precursor solution comprises mixing a first polyimide precursor and a second polyimide precursor together to form the precursor solution, wherein the first polyimide precursor comprises a bisanhydride precursor compound in a first solvent and the second polyimide precursor comprises a diamine precursor compound in a second solvent.

### Embodiment 20

The method according to any one of Embodiments 12-19, further comprising: absorbing a second precursor solution into porosity of the polyimide part formed by the plurality of layers, the second precursor solution comprising the polyimide precursor compound in a second solvent; and heating the polyimide part to initiate polymerization of the polyimide precursor compound of the second precursor solution in the porosity to increase overall density of the polyimide part.

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

This application claims priority to U.S. Provisional Application No. 62/170,423, filed on Jun. 3, 2015, the entire disclosure of which is incorporated herein by reference. The subject matter of U.S. Provisional Application No. 62/170,413, and the U.S. Provisional Application No. 62/170,418, are also incorporated by reference as if reproduced herein in their entireties. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a molding system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods or method steps as described in the above examples. An implementation of such methods or method steps can include code, such as microcode, assembly language code, and higher-level language code. Such code can include computer readable instructions for performing various methods. The code may form portions of computer program products. The code can be tangibly stored on one or more volatile, non-transitory, or non-volatile tangible computer-readable media. Examples of these tangible computer-readable media can include, but are not limited to, hard disks, removable magnetic disks, removable optical disks (e.g., compact disks and digital video disks), magnetic cassettes, memory cards or sticks, random access memories (RAMs), and read only memories (ROMs).

Although the invention has been described with reference to exemplary embodiments, workers skilled in the art will recognize that changes may be made in form and detail without departing from the spirit and scope of the invention.

1. A system for fabricating an article, the system comprising:
an extrusion head configured to selectively extrude a bead of a precursor solution onto a target road on a substrate within a build area, the precursor solution comprising a polyimide precursor compound in a solvent;
an extrusion head actuator coupled to the extrusion head to move the extrusion head;
a control system coupled to the extrusion head actuator to control the extrusion head actuator to control the extrusion head along the target road and selectively dispense the precursor solution to the extrusion head; and
an environmental system configured to accommodate the target road during fabrication of the article, the environmental system configured to expose the dispensed precursor solution to a temperature selected to evaporate solvent from the solution to initiate polymerization of the polyimide precursor compound to form at least a portion of a polyimide part.

2. The system according to claim 1, wherein the polyimide precursor compound comprise at least one of a bisanhydride precursor compound, a diamine precursor compound, and a reaction product of a bisanhydride precursor compound and a diamine precursor compound.

3. The system according to claim 2, wherein the reaction product is formed by a process comprising one of:
dissolving the bisanhydride precursor compound and the diamine precursor compound in water in the presence of a secondary or tertiary amine to provide the precursor solution;
dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the precursor solution; or
dissolving the bisanhydride precursor compound and the diamine precursor compound in a mixture of water and an aliphatic alcohol to provide the precursor solution.

4. The system according to claim 3, wherein the bisanhydride precursor compound and the diamine precursor compound are dissolved in a substantially equimolar ratio.

5. The system according to claim 1, wherein the solvent comprises at least one of water and an aliphatic alcohol.

6. The system according to claim 1, wherein the extrusion head comprising a heater to heat the precursor solution to a polymerization temperature as the precursor solution is extruded from the extrusion head.

7. The system according to claim 6, wherein the extrusion head comprises an extrusion nozzle through which the precursor solution is extruded, wherein the heater heats at least a portion of the extrusion nozzle to preheat the precursor solution.

8. The system according to claim 7, wherein the heated portion of the nozzle comprises a non-uniform portion of a perimeter of the extrusion nozzle.

9. The system according to claim 1, wherein the precursor solution comprises a first one of a bisanhydride precursor compound and a diamine precursor compound in a first solvent, the system further comprising a second extrusion head configured to selectively extrude a bead of a second precursor solution onto the target road within a build area, the second precursor solution comprising a second one of the bisanhydride precursor compound and the diamine precursor compound in a second solvent.

10. The system according to claim 1, further comprising:
a first dispenser configured to dispense a first polyimide precursor to the extrusion head, the first polyimide precursor comprising a bisanhydride precursor compound in a first solvent; and
a second dispenser configured to dispense a second polyimide precursor to the extrusion head, the second polyimide precursor comprising a diamine precursor compound in a second solvent;
wherein the extrusion head comprises a mixing zone to mix the first polyimide precursor and the second polyimide precursor to form the precursor solution prior to extrude the bead of the precursor solution onto the target road on the substrate within the build area.

11. The system according to claim 1, wherein the extruded bead of precursor solution has a cross-sectional shape with substantially top, bottom, and side edges.

12. A method of fabricating a part, the method comprising:
selectively extruding a bead of a precursor solution onto a target road on a substrate, the precursor solution comprising a polyimide precursor compound in a solvent; and
heating the extruded bead of precursor solution to initiate polymerization of the polyimide precursor compound into a structure including polyimide.

13. The method according to claim 12, wherein the polyimide precursor comprises at least one of a bisanhydride precursor compound, a diamine precursor compound, and a reaction product of a bisanhydride precursor compound and a diamine precursor compound.

14. The method according to claim 13, further comprising preparing the precursor solution by a process comprising one of:
dissolving the bisanhydride precursor compound and the diamine precursor compound in water in the presence of a secondary or tertiary amine to provide the precursor solution;
dissolving the bisanhydride precursor compound and the diamine precursor compound in an aliphatic alcohol to provide an alcohol-based polyimide precursor and optionally adding a secondary or tertiary amine to the alcohol-based polyimide precursor to provide the precursor solution; or
dissolving the bisanhydride precursor compound and the diamine precursor compound in a mixture of water and an aliphatic alcohol to provide the precursor solution.

15. The method according to claim 14, wherein the bisanhydride precursor compound and the diamine precursor compound are dissolved in a substantially equimolar ratio.

16. The method according to claim 12, wherein selectively extruding the bead of the precursor solution is performed with an extrusion head, the method further comprising preheating the precursor solution to a polymerization temperature at the extrusion head.

17. The method according to claim 16, wherein preheating the precursor solution at the extrusion head comprises heating a non-uniform portion of a perimeter of the extruded bead of precursor solution.

18. The method according to claim 12, wherein the precursor solution comprises a first one of a bisanhydride precursor compound and a diamine precursor compound in a first solvent, the method further comprising selectively extruding a bead of a second precursor solution onto the target road within a build area, the second precursor solution comprising a second one of the bisanhydride precursor compound and the diamine precursor compound in a second solvent.

19. The method according to claim 12, wherein selectively extruding the precursor solution comprises mixing a first polyimide precursor and a second polyimide precursor together to form the precursor solution, wherein the first polyimide precursor comprises a bisanhydride precursor compound in a first solvent and the second polyimide precursor comprises a diamine precursor compound in a second solvent.

20. The method according to claim 12, further comprising:
absorbing a second precursor solution into porosity of the polyimide part formed by the plurality of layers, the second precursor solution comprising the polyimide precursor compound in a second solvent; and
heating the polyimide part to initiate polymerization of the polyimide precursor compound of the second precursor solution in the porosity to increase overall density of the polyimide part.
